(19) United States
(12) Patent Application Publication
(10) Pub. No.: US 2025/0350485 A1
(43) Pub. Date: Nov. 13, 2025

(54) ENHANCED CONTROL AND AUTOMATION OF COMMUNICATION SESSION TRANSITIONS

(71) Applicant: Microsoft Technology Licensing, LLC, Redmond, WA (US)

(72) Inventor: Amer Aref HASSAN, Kirkland, WA (US)

(21) Appl. No.: 18/662,667

(22) Filed: May 13, 2024

(51) Int. Cl. H04L 12/18

(52) U.S. Cl. CPC H04L 12/1818; H04L 12/1822

(57) ABSTRACT

Disclosed techniques provide enhanced controls for transitions between communication sessions. A system automatically generates a UI prompt to join a next back-to-back meeting in response to a predetermined event that ends, terminates, or concludes an in-progress meeting. In one embodiment, while a user is participating in a meeting, the system generates an automatic UI providing a notification of one or more upcoming meetings. In response to a user selection of one of the upcoming meetings, the system invokes an operating mode where the user is automatically transitioned to the selected meeting when the user disconnects from their current meeting. In another embodiment, when the user disconnects from their current meeting, the system automatically generates a UI prompt to allow the user to select an upcoming meeting. Once a meeting is selected, the system can disconnect the user from the current meeting and automatically connect the user to the selected meeting.

### BACKGROUND

There are a number of different types of collaborative systems that allow users to communicate. For example, some systems allow people to collaborate by sharing content using video and audio streams, shared files, chat messages, etc. Some systems manage communication sessions, which are also referred to herein as online meetings, a virtual reality sessions, broadcasts, etc. Such sessions are also referred to as events that have a distinct start time and an end time that occur on specific dates. People can schedule these sessions on a calendar and have a number of events scheduled throughout the day. Users can schedule meetings in advance, invite other participants, and use various features such as audio, video, chat, screen sharing, whiteboards, etc. Users can also access their calendar from a number of different applications, which shows their upcoming and past meetings, as well as their availability status. In some instances, people may have multiple events scheduled for the same timeslot. Each event can also define a list of participants, roles of the participants, permissions for accessing specific content.

Although some systems can provide a number of features that allow people to collaborate during specific events, such systems have a number of drawbacks. For example, when users have scheduled back-to-back meetings, users have to provide a number of manual inputs to control the transition between their meetings as they progress through their schedule. In one specific example, when a person is in a virtual meeting, and approaching the end of that meeting, they have to provide a number of manual inputs to view the context of upcoming meetings, provide yet additional inputs to leave the meeting they are in, provide yet more inputs to select an upcoming meeting, then provide yet more manual inputs to enter the selected meeting. This cumbersome not only leads to a loss of engagement, which leads to prolonged meetings and unnecessary use of computing resources, but it can lead to inadvertent inputs that may cause a premature termination of a meeting or missed opportunities for salient information.

Among other technical challenges of existing systems, participants may also have to deal with multiple conflicting meetings that start at the same time or overlap with one another. Such scenarios lead to a situation where participants may have to switch between multiple meetings to attend different parts of select meetings. Users may also have different preferences for joining the meetings, such as using audio only, video on or off, or using a phone call instead of the Teams app. Thus, if a person has two meetings that occur at the same time, they may want to join one meeting as a manager, then join another meeting as an audience member. If they have to switch between two meetings that are overlapping, it may be difficult to make that switch manually in a timely fashion, and do so with the correct permission and role settings. Human errors made in permission and role settings can leave attack vectors in a system and expose content and other important information.

### SUMMARY

The disclosed techniques provide enhanced controls for transitions between communication sessions. A system automatically generates a UI prompt to join a next back-to-back meeting in response to a predetermined event that ends, terminates, or concludes an in-progress meeting. The UI prompt can include prioritized meetings among many upcoming meetings that are scheduled in the same time slot. In one embodiment, while a user is participating in a meeting, the system generates an automatic UI providing a notification of one or more upcoming meetings. In response to a user selection of one of the upcoming meetings, the system invokes an operating mode where the user is automatically transitioned to the selected meeting when the user disconnects from, e.g., leaves, their current meeting. In another embodiment, when the user provides an input to disconnect from their current meeting, instead of terminating the meeting immediately, the system automatically generates a UI prompt to allow the user to select an upcoming meeting. The UI prompt can include a single meeting or a list of prioritized meetings. Once a meeting is selected, the system disconnects the user from the current meeting and automatically connects the user to the selected meeting.

In some embodiments, the UI prompt can include a prioritized list of upcoming meetings that is based on the user's calendar information, preferences, and historical information. For instance, a particular meeting hosted by the user, e.g., the recipient of the UI prompt, can be ranked higher than other meetings that are hosted by other users. A meeting hosted by specific people or groups of people who have a history that meets certain criteria can also be ranked higher than other meetings that do not meet the criteria. The UI prompt can also display properties of each upcoming meeting to help a user select an upcoming meeting to attend. For instance, the UI prompt can describe upcoming meetings as recurring or as a stand-alone meeting. The UI prompt can also list a host of an upcoming meeting and other status information, who is attending, whether a meeting is canceled, etc.

The disclosed techniques simplify the user experience of joining individual meetings or a set of meetings that are back-to-back or are at least partially overlapping in time. In particular, the disclosure features simplify the existing joining flow where users may have to manually end the current meeting, find the next meeting in their calendar, and join a next meeting and/or an overlapping meeting. The disclosed features also guide users into joining multiple conflicting meetings that start at the same time or overlap with each other at least partially. The system helps users by selecting or prioritizing meetings to join, or switch between multiple meetings to attend different select parts of each meeting. The system can also select meetings and join them using different preferences for joining the meetings, such as using audio only, video on or off, or using a phone call instead of a communication desktop application, etc.

The disclosed techniques address the technical issues pertaining to complex input flows for transitioning between meetings by providing technical solutions that generate notifications for brining awareness to, and providing controls for, upcoming or conflicting meetings. In some embodiments, a system can analyze events on a person's calendar to determine if they have meetings that are adjacent, e.g., within a threshold time of one another or have a threshold time gap between them. As described herein, the time gap between meetings can include a time between meetings, or a gap can be negative, indicating how much two meetings overlap. The system can cause an analysis of calendar data to determine that a time gap between a first communication session and a second communication session is below a time gap threshold. The system can also monitor an elapsed time during the first session, e.g., meeting, for providing notice near the end of the meeting. This can include analyzing an elapsed time during the first communication session to determine that the elapsed time of the first communication session is within a timing threshold of an end time of the communication session. The system will only display a notification about the upcoming/adjacent meeting near the end of the first meeting, e.g., last two minutes in the first meeting. The timing of this notification can be based on who the presenter is in the next meeting, how much content is shared, etc. In response to determining that the time gap between the first communication session and the second communication session is below the time gap threshold, and in response to determining that the elapsed time of the first communication session is within the timing threshold of the end time of the communication session, the system causes a display of a user interface element having a notification describing one or more properties of the second communication session, wherein the user interface element includes a selectable control element that causes a transition to the second communication session. A user selection of the selectable control element to join the next meeting conducts two actions, leaves the current meeting and enters the next meeting. The system can receive an input at the selectable control element that causes the transition to the second communication session, wherein the input is received at a computing device. Then, in response to receiving the input at the selectable control element that causes the transition to the second communication session, controlling at least one of audio signals, video signals, and shared content of the second communication session to the computing device associated with the received input.

The system can automatically connect the user's computer to an adjacent meeting based on one of a number of different types of actions. For instance, when a user leaves the first meeting, if the second meeting is adjacent, as defined herein, the system can automatically connect that user to the second meeting. In another example, when the first meeting is terminated, has concluded, or has ended, if the second meeting is adjacent, as defined herein, the system can automatically connect that user to the second meeting. In yet another example, when the first meeting runs the course of an agenda of that meeting, e.g., if the agenda defines the end of the meeting 10 minutes before the time slot allocation and the meeting runes through that last agenda item, if the second meeting is adjacent, as defined herein, the system can automatically connect that user to the second meeting. The user is not automatically connected to the second meeting if the second meeting does not meet the criteria as qualifying as being adjacent.

The system can also automatically control permissions during the automated transition. The permission can be controlled by one or more preferences and a meeting type, and a role of the person being transitioned between meetings. For example, consider a scenario where a user has a preference file indicating that when they are audience members of a meeting they have set permissions that allow other users of the meeting to access a first set of files and not have access to a second set of files. The preferences can also indicate that when that person is a presenter, they allow other users of the meeting to access a second set of files. While they are presenter the preferences can either allow the other attendees to have access to the first set of files or restrict the first set of files for the other attendees. This enables the system to automatically transition permissions for sets of files depending on their role in meetings. Thus, if a user transitions from our first meeting where they are an audience member, to a second meeting where they are a presenter, the system automatically changes access to the set of files for the other meeting attendees. In such an example, a person may not allow access to files during their first meeting but after the automated transition to the second meeting, the system automatically changes permissions to their files and allows access to audience members when they are a presenter.

The system can change roles and/or permissions for the user depending on a meeting type as well. For instance, for meetings with a first set of audience members with a first set of roles, a person may be automatically given a presenter title with a first set of permissions, e.g., access to shared content that lists them as an owner. For meetings with a second set of audience members with a second set of roles, a person may be automatically given a moderator title with a second set of permissions, e.g., full administrative control over all shared content.

The system can also utilize an AI model, such as a large language model, to predict preferences for users. For example, if a user has two upcoming meetings with two different groups of people, the system can analyze that person's past meanings to determine which group they met in the past. Based on one or more metrics, e.g., how many times they meet with each group or individuals listed in each of the upcoming meetings, the system recommends or ranks the upcoming meetings. Thus, prior to the currently attended meeting, the system may see two upcoming meetings and rank the one meeting over another because the first meeting lists attendees that the person has met with more frequently or met with in total over the attendees of the second meeting. These decisions can also be based on title or roles of each of the attendees and also shared content. As described in more detail herein, historical attendance and metadata related to each meeting can be sent to an AI model for training data and or queries for determining a priority of any upcoming meetings.

The techniques disclosed herein can provide a number of technical effects including enhancing the security of a communication system. By automating the assignment of roles and permissions, a system can enhance security by mitigating the need for users to perform manual steps to change permissions during an event. Automatically assigned permissions that are based on a sequence of events of a hand raise an order in which users are speaking can reduce the need for a manual input for changing roles and/or permissions and thereby reduce introduction of human error. Such an arrangement can reduce the number of attack vectors and exposure to a number of security threats. For example, if a user manually assigns a role to a participant and then does not relinquish rights for a microphone broadcast mode when they are no longer a speaker, that person may inadvertently have an unwanted broadcast. This automated system can help avoid such security issues.

In addition to improving the security of a system, the techniques disclosed herein can provide a number of efficiencies. By providing automated transitions, or semi-automated transitions only requiring one verification from a user, meeting participants can move between meetings and spend less time controlling permissions and meeting controls and focus on salient points with minimal interruptions. When information and transitions are organized more accurately and with fewer manual inputs, audience members are less likely to miss salient information during an event. Such benefits can increase the efficiency of a computing system by reducing the number of times a user needs to interact with a computing device to obtain information, e.g., prolonging meetings, retrieving meeting recordings, requesting duplicate copies of previously shared content, etc. Thus, various computing resources such as network resources, memory resources, and processing resources can be reduced.

The techniques disclosed herein also provide a system with more automated controls when transitioning a person between meetings and aligning permissions to specific roles of an event. Such features can also lead to a more desirable user experience. In particular, by automatically transitioning a person between meetings, a system can reduce the number of times a user needs to interact with a computing device to control roles and security permissions. This can lead to the reduction of manual data entry that needs to be performed by a user. By reducing the need for manual entry, inadvertent inputs and human error can be reduced. This can ultimately lead to a reduction in undesirable permissions and more efficient use of computing resources such as memory usage, network usage, processing resources, etc.

Features and technical benefits other than those explicitly described above will be apparent from a reading of the following Detailed Description and a review of the associated drawings. This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter of a sequence of letters to refer to each individual item. Generic references to the items may use the specific reference number without the sequence of letters.

FIG. 1A is a block diagram of a system for providing enhanced control and automation of communication session transitions, the system in an operating state where an elapsed time of a meeting is monitored to determine if a notification is to be displayed regarding an upcoming meeting.

FIG. 1B is a block diagram of a system for providing enhanced control and automation of communication session transitions, the system in an operating state where an elapsed time of a meeting has met a condition with respect to one or more thresholds to issue a notification regarding an upcoming meeting.

FIG. 1C is a block diagram of a system for providing enhanced control and automation of communication session transitions, the system in an operating state where a computer receives an input at a notification for selecting an upcoming meeting.

FIG. 1D shows the system entering an operating mode where the user is automatically transitioned to the selected meeting when the user disconnects from, e.g., “Leaves” their current meeting.

FIG. 1E shows the system in an operating mode of FIG. 1D, and where the system receives an input causing the user to terminate their connection, e.g., disconnect from or leave, their current meeting.

FIG. 1F shows a phase of the process where the system concurrently closes the first meeting and adds a user to a selected meeting in response to the input causing the user to leave the first meeting.

FIG. 2A shows the system operating in an automated transition mode where the where the system automatically generates a UI showing adjacent meetings when the user disconnects from a meeting.

FIG. 2B shows a phase of the process where a system determines that the communication session has ended, is terminated, or has concluded.

FIG. 2C shows a phase of the process where the system retrieves and displays the information for the meetings that quality as upcoming communication sessions, e.g., adjacent meetings.

FIG. 2D shows a phase of the process where the user provides an input selecting at least one of the upcoming meetings.

FIG. 2E shows a phase of the process where the system concurrently closes the first meeting and adds the person to the selected meeting in response to the selection of the upcoming meeting.

FIG. 3A is an example of a UI for providing enhanced control and automation of communication session transitions, a system in an operating state where an elapsed time of a meeting is monitored to determine if a notification is to be displayed regarding a conflicting meeting.

FIG. 3B is an example of a UI for providing enhanced control and automation of communication session transitions, a system in an operating state where an elapsed time of a meeting has met a condition with respect to one or more thresholds to issue a notification regarding a conflicting meeting.

FIG. 3C shows the system in an operating state where a computer receives an input at a notification for selecting an upcoming meeting.

FIG. 3D shows the system entering an operating mode where the user is automatically transitioned to the selected meeting when the user disconnects from, e.g., “Leaves” their current meeting.

FIG. 3E shows the system in an operating mode of FIG. 3D, and where the system receives an input causing the user to terminate their connection, e.g., disconnect from or leave, their current meeting.

FIG. 3F shows a phase of the process where the system concurrently closes the first meeting and adds a user to a selected meeting in response to the input causing the user to leave the first meeting.

FIG. 4A is an example of a UI for providing enhanced control and automation of communication session transitions, a system in an operating state where an elapsed time of a meeting is monitored to determine if a notification is to be displayed regarding a conflicting meeting.

FIG. 4B is an example of a UI for providing enhanced control and automation of communication session transitions, a system in an operating state where an elapsed time of a meeting has met a condition with respect to one or more thresholds to issue a notification regarding a conflicting or adjacent meeting.

FIG. 4C is an example of an interim operating state where the computer of a user enters a second meeting, e.g., an adjacent or overlapping meeting, before exiting a first meeting.

FIG. 4D is an example where, during an interim operating state where the computer of a user is in a second meeting and a first meeting and enters an input to leave the first meeting.

FIG. 4E is an example of where the user enters the second meeting and after they leave a first meeting that they were concurrently viewing with the second meeting.

FIG. 5 is an example of a UI for providing enhanced control and automation of communication session transitions, a system displaying a notification of multiple prioritized upcoming meetings.

FIG. 6 is an example of a switch control system that controls a computer to switch between conflicting meetings based on an agenda of the conflicting meetings.

FIG. 7A shows an example of how an event of a calendar does not meet one or more conditions with respect to a time gap threshold.

FIG. 7B shows an example of how an event of a calendar meets one or more conditions with respect to a time gap threshold.

FIG. 7C shows an example of how an event of a calendar having a negative time gap meets one or more conditions with respect to a time gap threshold.

FIG. 8A shows an example of how an event of a calendar does not meet one or more conditions with respect to a timing threshold.

FIG. 8B shows an example of how an event of a meets one or more conditions with respect to a timing threshold.

FIG. 8C shows an example of how an overlapping event of a calendar meets one or more conditions with respect to a timing threshold.

FIG. 9 shows a block diagram of a system that utilizes a large language model to determine a priority of conflicting meetings.

FIG. 10 is a flow diagram showing aspects of a routine for providing enhanced control and automation of communication session transitions.

FIG. 11 is a diagram illustrating a distributed computing environment capable of implementing aspects of the techniques and technologies presented herein.

FIG. 12 is a computer architecture diagram illustrating a computing device architecture for a computing device capable of implementing aspects of the techniques and technologies presented herein.

### DETAILED DESCRIPTION

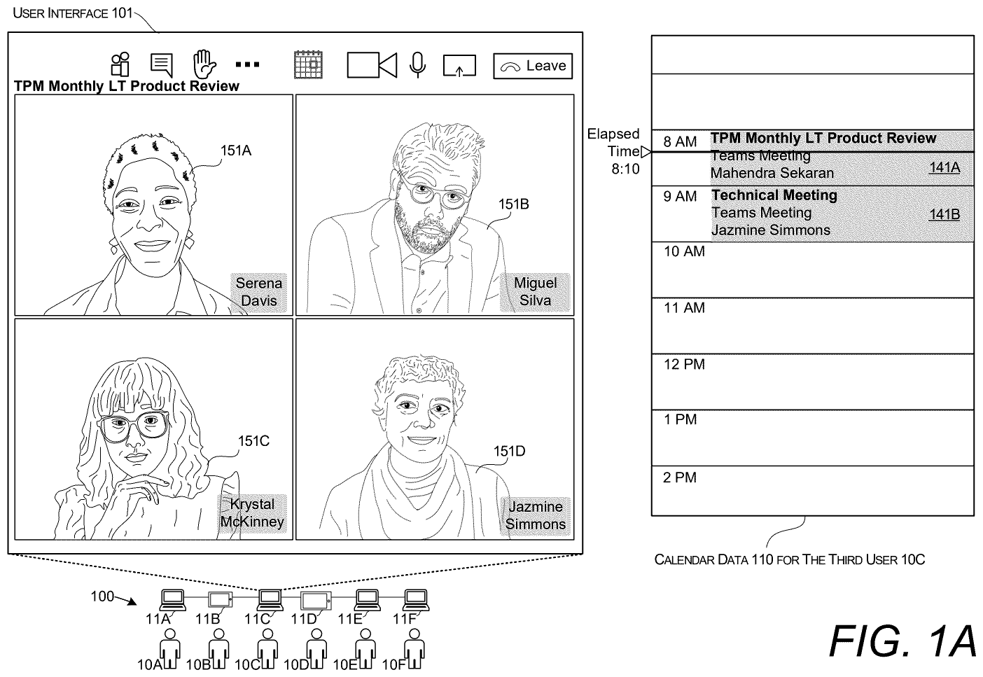

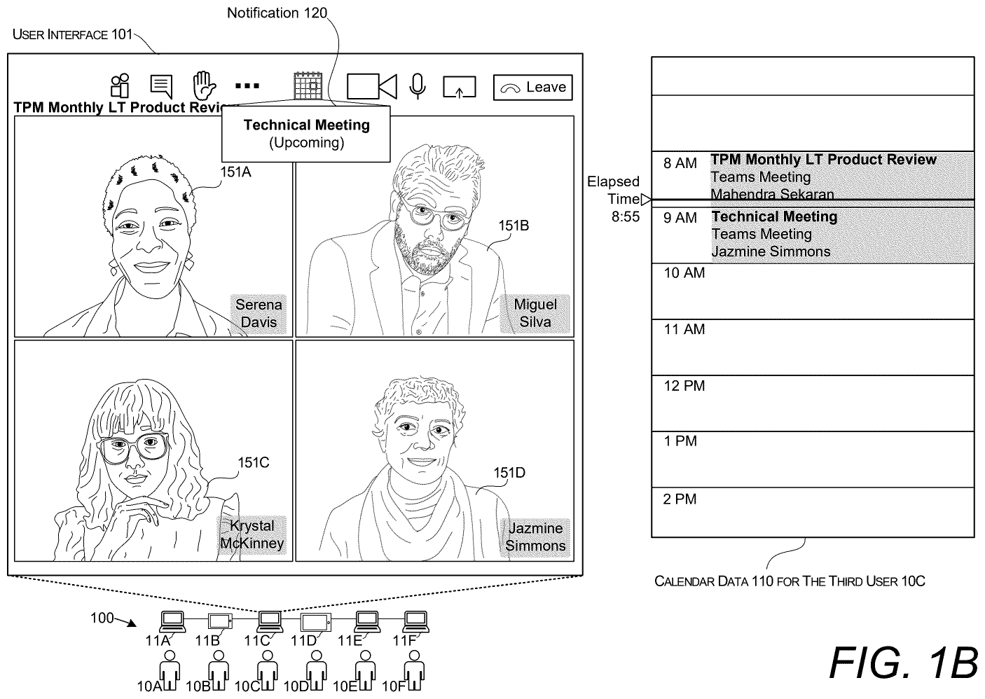

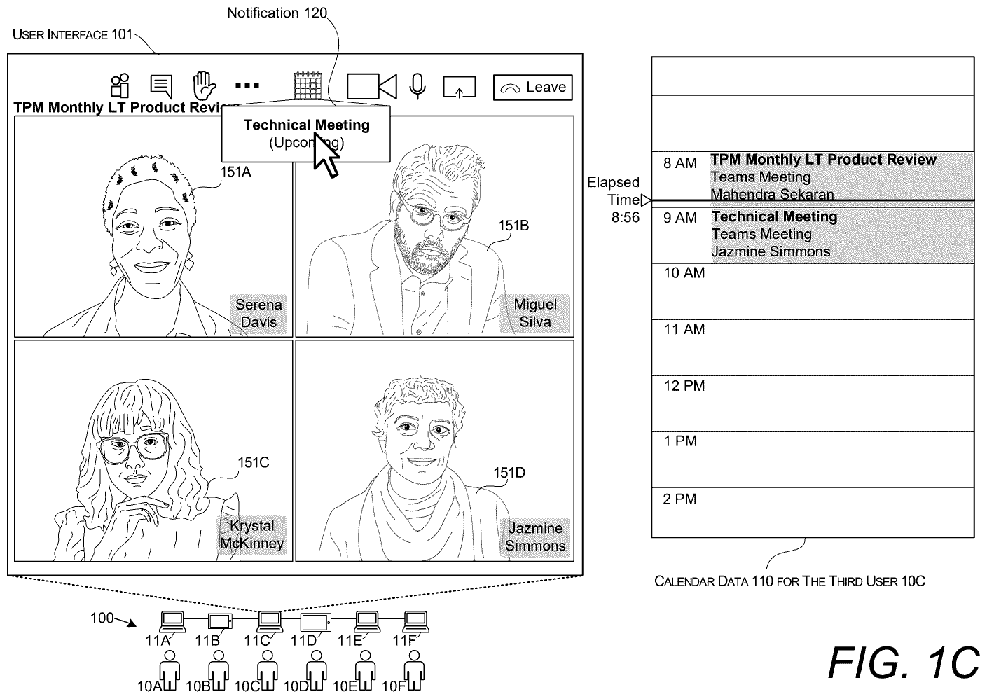

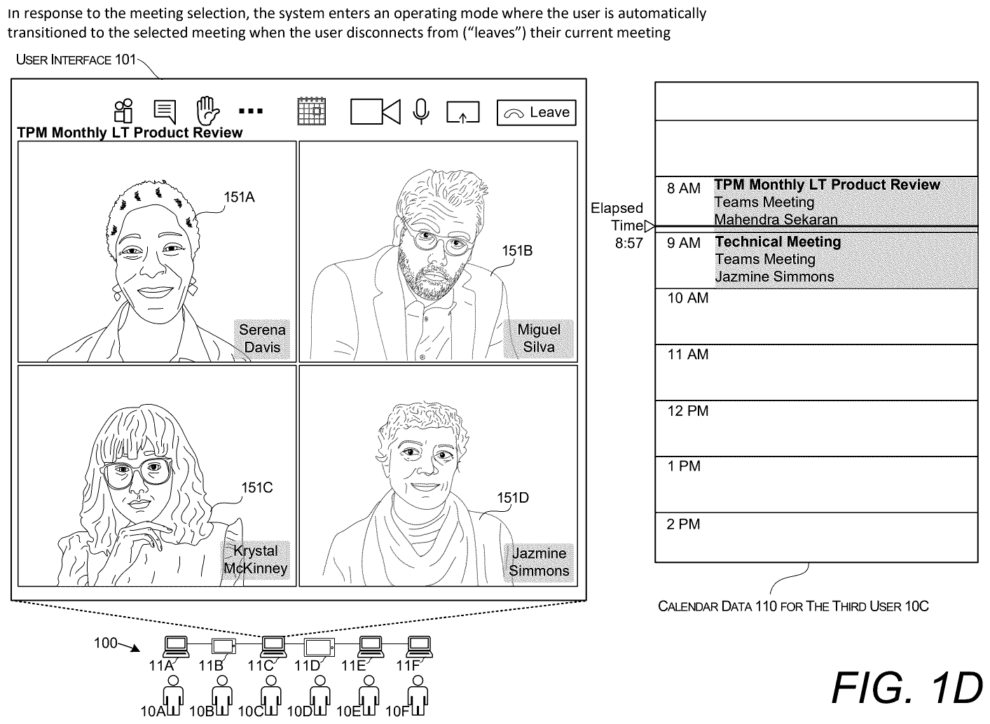

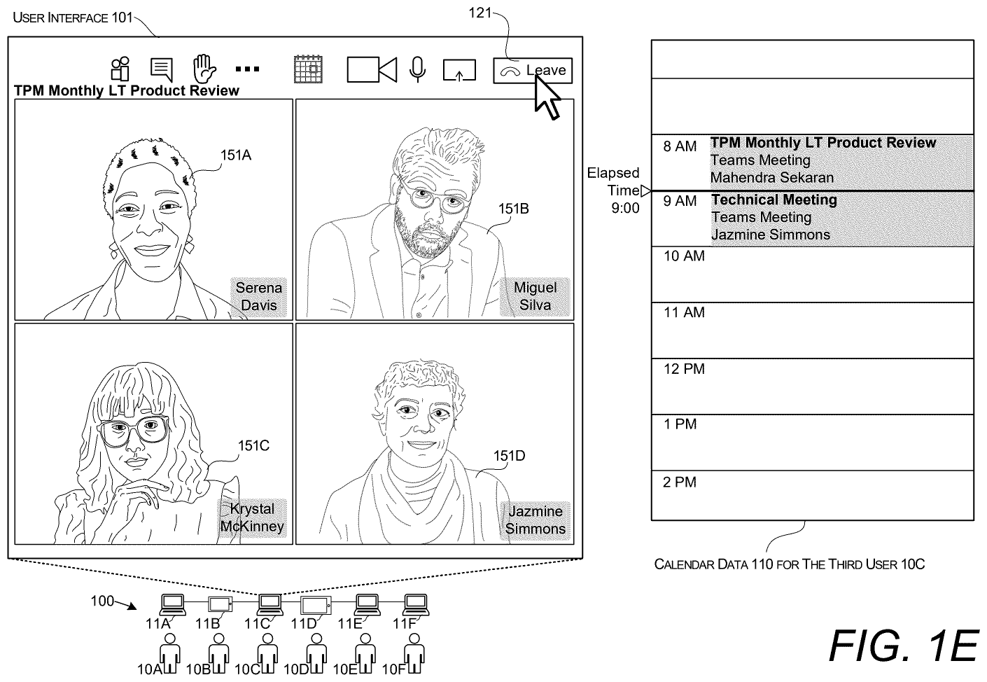

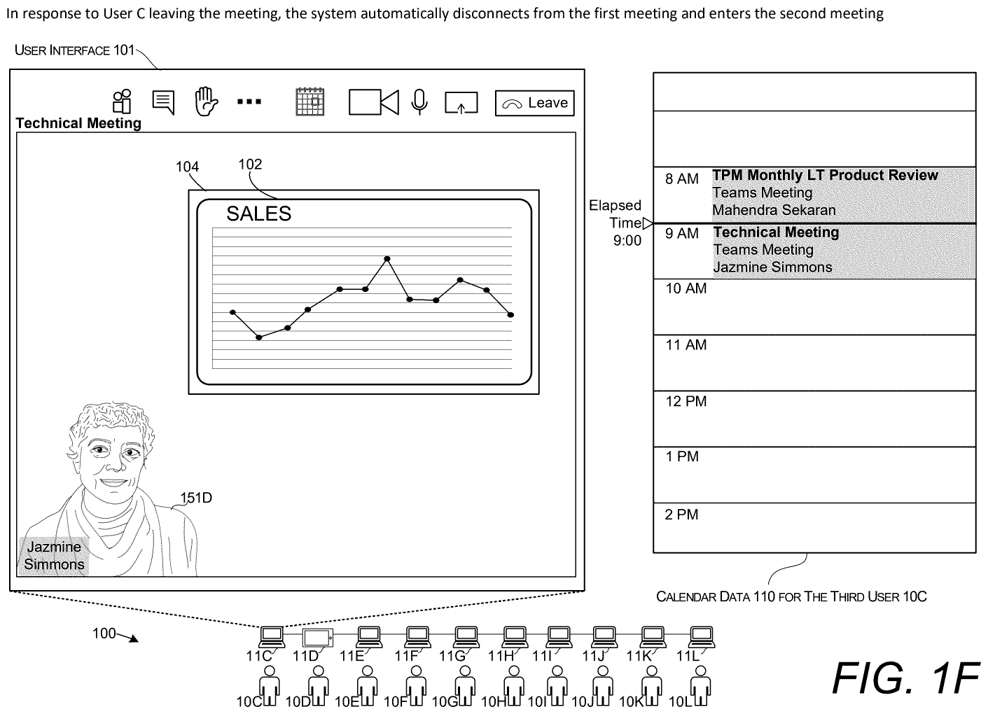

FIGS. 1A-1D illustrate a system 100 that provides enhanced control and automation of communication session transitions. In some configurations, a system provides an automatic UI prompt to join a conflicting meeting or to join an upcoming back-to-back meeting. In this embodiment, while a user is participating in a meeting, the system generates an automatic UI providing a notification of one or more upcoming meetings. In response to a user selection of one of the upcoming meetings, the system invokes an operating mode where the user is automatically transitioned to the selected meeting when the user disconnects from (“leaves”) their current meeting.

As shown in FIG. 1A, the system 100 includes a number of computing devices 11 each associated with a user 10. The computers are each interconnected using a communication session for sharing video signals, audio signals, and shared content. In this example, there are a number of users (10A-10F) in a meeting, where User 1 10A, Serena Davis, is associated with a computing device 11A, User 2 10B, Miguel Silva, is associated with another computing device 11B, User 3 10C, Krystal Mckinney, is associated with another computing device 11C, and User 4 10D, Jazmine Simmons, is associated with yet another computing device 11D, and other users 10E-10F are associated with other corresponding devices 11E-11F. The users of this communication session are participating in a first meeting 141A having a first set of participants. As will be described below, the second communication session is for a second meeting 141B having a second set of users.

Each user 10 is represented in a user interface 101 by a rendering 151, e.g., the first user 10A is represented by a first rendering 151A, the second user 10B is represented by a second rendering 151B, etc. For illustrator purposes, the user interface shown in these figures is generated at the third computer 11C for User C 10C. Correspondingly, the calendar data 110 used for this example is the calendar associated with the third computer and the third user. Using this calendar data and other criteria, the system generates a timely notification with controls a process for transitioning from the first meeting 141A to the second meeting 141B.

FIG. 1A shows the system in an operating state where an elapsed time of a meeting is monitored to determine when and if a notification is to be displayed regarding an upcoming meeting. In this example, the first meeting “TMP Monthly LT Product Review” 141A is in progress and is at an elapsed time of 10 minutes into the meeting, e.g., current time as at 8:10. During the first meeting or before the first meeting, the system analyzes the times of each event to determine if they are adjacent, e.g., within a threshold time of one another. An adjacent meeting in the context of the present disclosure means that a second meeting has a start time that is within the threshold of time (within the time gap threshold) of the end time of the first meeting. If the second meeting does not meet this condition, the system does not execute the automated actions described herein, such as automatically displaying the properties of the second meeting. This is the condition shown in FIG. 1A, where a notification of the qualified upcoming meetings are not displayed.

In this example, if the second meeting “Technical Meeting” 141B has a start time that is within a threshold time gap of the end time of the first meeting, the system can determine that a time gap between a first meeting and a second meeting is below a time gap threshold. This allows the system to filter meetings so that notifications are not displayed when there is more than a threshold amount of time between the meetings. If there is more than a threshold time gap between the meetings, the system will not display a notification of the upcoming meeting.

During the first meeting, the system also analyzes the time, e.g., an elapsed time of a meeting, against the calendar data 110 to determine when a notification should be displayed. The system monitors the time during the first meeting for providing notice within a threshold of time of the end of the first meeting, e.g., within the last 5 minutes, last 2 minutes of a meeting, etc. The system can analyze an elapsed time during the first meeting to determine that the elapsed time of the first meeting is within a timing threshold of an end time of the first meeting. In another embodiment, the system can analyze an elapsed time during the first meeting to determine that the elapsed time of the first meeting is within a timing threshold of a start time of the second meeting.

In some embodiments, the system only displays a notification about the adjacent meeting near the end of the first meeting, e.g., last two minutes in the first meeting, or within a threshold time of the start of the second meeting. For example, as shown in FIG. 1B, in response to determining that the time gap between the first meeting and the second meeting is below the time gap threshold, and in response to determining that the elapsed time of the first meeting is within the timing threshold of the end time of the first meeting, the system causes a display of a user interface element having a notification describing one or more properties of the second meeting. The user interface element also includes a selectable control element that allows a user to select one or more of the upcoming meetings displayed on the user interface element 120.

In another embodiment, in response to determining that the time gap between the first meeting and the second meeting is below the time gap threshold, and in response to determining that the elapsed time of the first meeting is within the timing threshold of the start time of the second meeting, the system causes a display of a user interface element having a notification describing one or more properties of upcoming meetings, such as the second meeting. The user interface element also includes a selectable control element that allows the selection of one or more upcoming meetings.

Next, as shown in FIG. 1C, a user input is received at the third client device 11C indicating a selection of one or more upcoming meetings. In response to receiving an input indicating a selection of one or more upcoming meetings, the system enters an operating mode where the system or the computer of a user, such as User C providing the input, is automatically transitioned to the selected meeting when the user provides an input to disconnect from, e.g., “leaves,” their current meeting. This operating mode is shown in FIG. 1D, where the system awaits an input indicating that the user, e.g., User C 10C, is to leave the meeting. In this operating mode, the system automatically disconnects the user from a current communication session and connects the user to a second selected meeting when a leave input command is received from the user. If this operating mode is not activated, the system only disconnects the user from a current communication session when a leave input command is received from the user.

Then, as shown in FIG. 1E, a second input is received where the second input indicates that the third client device 11C is to leave the first meeting. Since the system is in the operating mode described above with respect to FIG. 1D, upon receiving the input indicating that the third computer 11C is to terminate the first communication session, the system automatically closes the current meeting, e.g., disconnect all communication of video and audio streams of the first communication session with the computer of the user. In addition, this second input also causes the system to automatically enter the second meeting, e.g., connect all video and audio streams of the second communication session with the computer of the user. Thus, the leave button can be used for two different functions based on the operating mode of the system. For instance, if the second meeting is not selected at the notification 120 prior to the leave button being pressed, the leave button only terminates the first communication session. However, if the second meeting is selected at the notification 120 prior to the leave button being pressed, the leave button then terminates the first communication session and automatically joins the selected meeting, e.g., the second communication session.

Then, as shown in FIG. 1F, in response to the second input, the system closes the first meeting and automatically joins the user to the second meeting. This transition can include operations for controlling at least one of the audio signals, video signals, and shared content of the first meeting to be restricted from communication between the client computer 11C and the first set of computing devices 11A, 11B, and 11D-11F of the first meeting. The input also controls at least one of audio signals, video signals, and shared content of the second selected meeting to be communicated between the client computer 11C and a second set of computing devices 11D-11L of the second meeting.

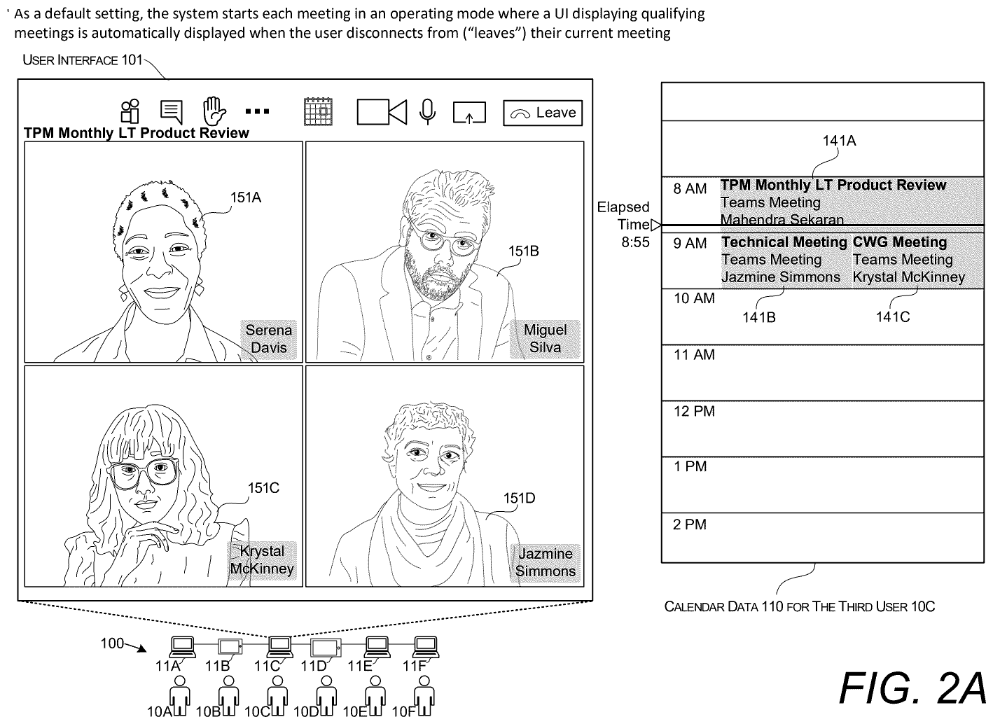

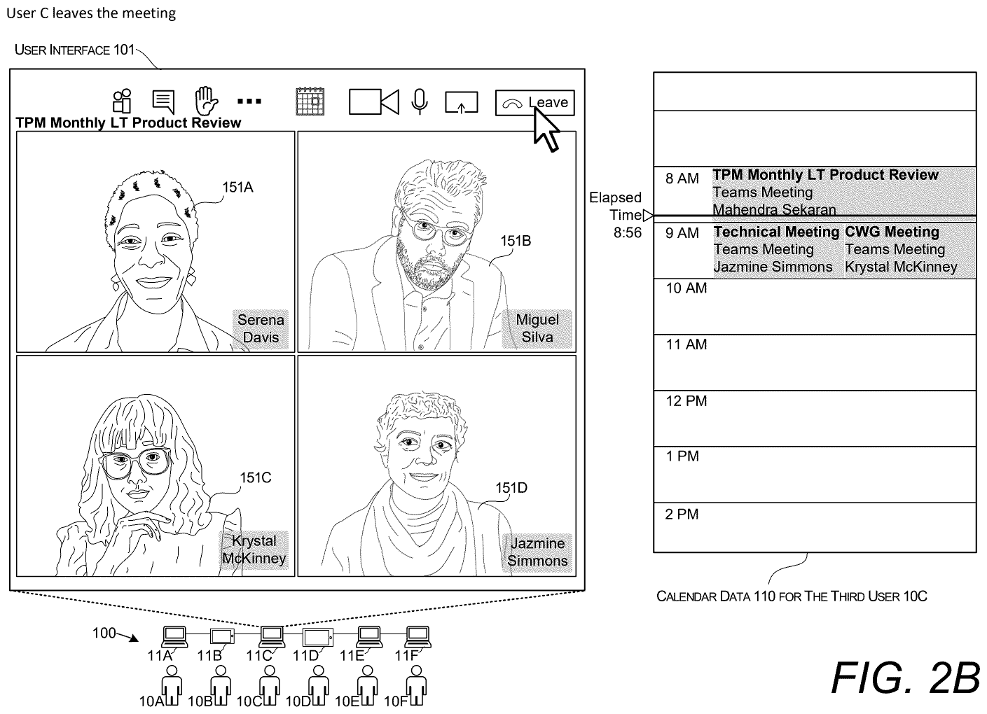

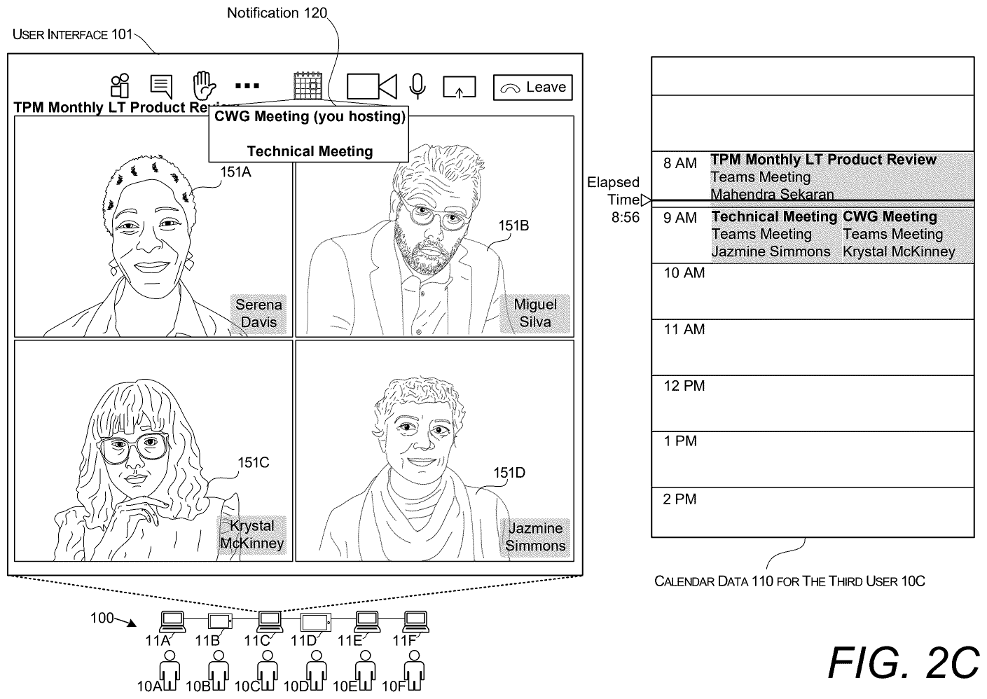

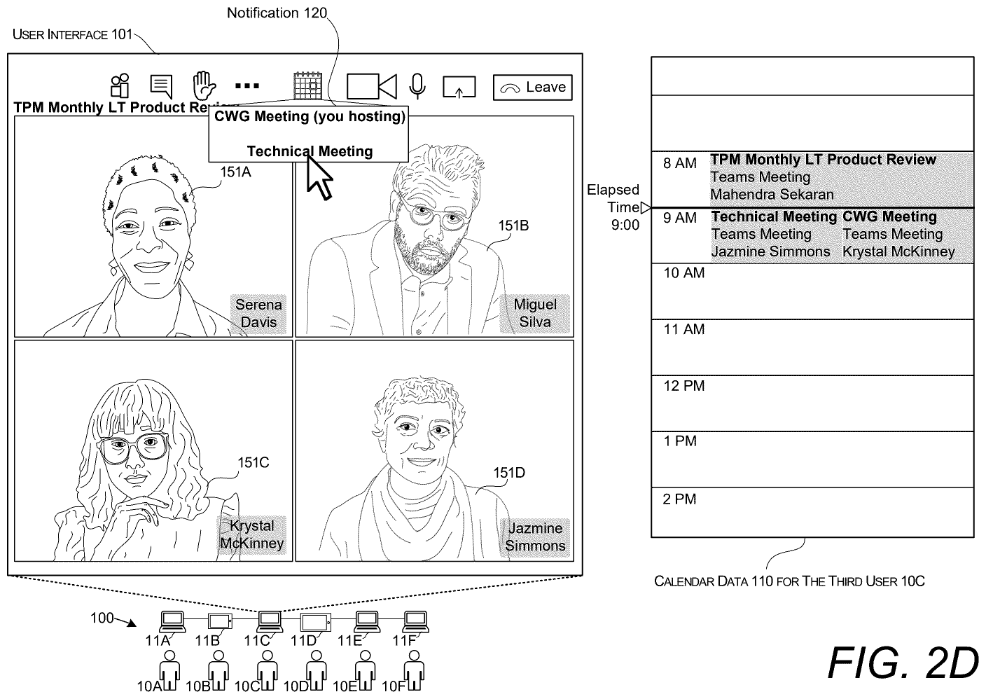

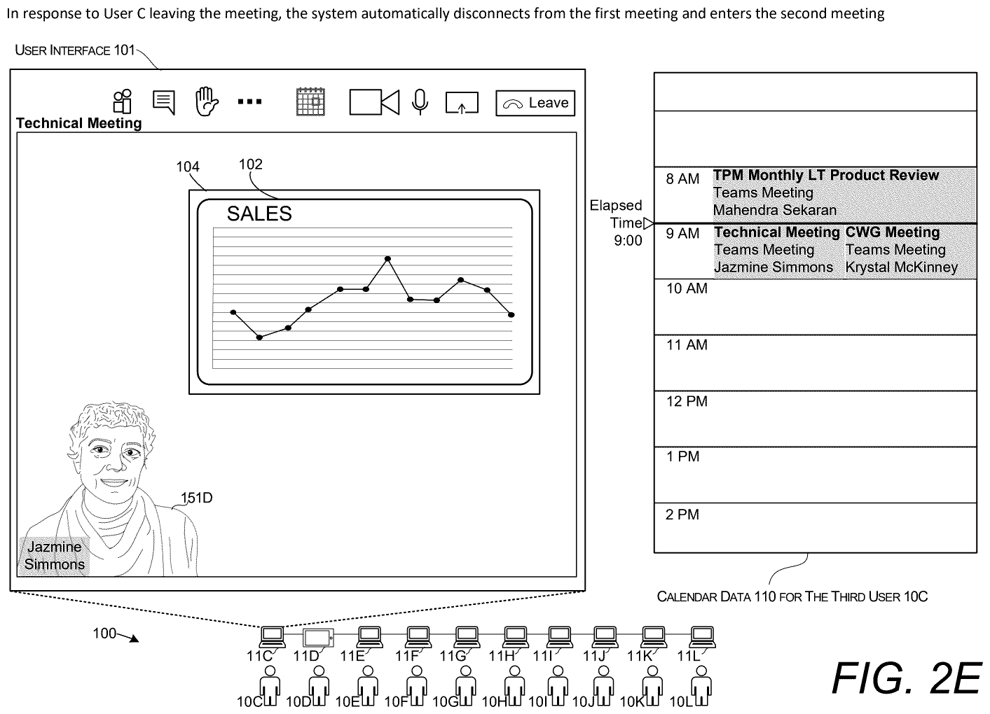

FIGS. 2A-2E are directed to an embodiment where the system automatically generates a UI prompt to allow the user to select an upcoming meeting in response to a particular user, e.g., User C 10C, providing an input to disconnect from a current meeting. Instead of having the user leave the meeting when the user provides an input to leave a meeting, the system transitions to an operating mode where, once a meeting is selected from the UI prompt, the system automatically disconnects the user from the current meeting and automatically connect the user to the selected meeting.

FIG. 2A shows the system operating in an automated transition mode where the where the system automatically generates a UI showing adjacent meetings when the user disconnects from, e.g., actuates the ‘Leave’ button, their current meeting. This special operating mode causes the specific action of retrieving and displaying the data for upcoming meetings that qualify as adjacent meetings. When the automated transition mode is off, the system does not display the special UI, and instead when the user provides an input to leave the meeting, the system terminates the audio and video signals for that particular meeting. For the state of the computer shown in FIG. 2A, the system invokes a first communication session 141A in an automated transition operating mode that causes the system to retrieve and display upcoming communication session properties in response to receiving an input for terminating the first communication session 141A for a client device 11C associated with a user 10C.

The automated transition mode can be invoked based on one or more factors. For example, the automated transition mode can be invoked when a meeting qualifies as an adjacent meeting, e.g., that the next meeting is within a threshold time gap as a first meeting. In another example, the automated transition mode can be invoked when one or more upcoming meetings have a threshold priority based on any of the factors described herein. For example, if an upcoming meeting has a score of 10 because the user is the host of that meeting, and the priority threshold is 9, the system can invoke the automated transition mode. The factors and criteria disclosed herein can be used by the system to invoke any operating state described herein. The factors and criteria can be based on at least one of user preferences, the user attendance history, the response status, the time proximity, or the recurrence status meeting one or more criteria.

FIG. 2B shows a phase of the process where the system determines that the first communication session, e.g., the first meeting, has ended, is terminated, or has concluded. In one embodiment, the system determines that the communication session is terminated when a user, such as User C 10C, provides an input to leave the meeting by pressing the “Leave” or a “hang up” button or providing a voice command, providing a predetermined gesture, etc. Although FIG. 2B shows one example where a user leaves a meeting, another triggering action for causing the retrieval of one or more properties for upcoming communication sessions can be utilized, such as the embodiments described below.

In another embodiment, the system determines that the communication session has ended by detecting that the meeting time is up. This can include analyzing a calendar item defining the communication session and determining that a running time of the communication session has reached the “end time” defined in the calendar event. For example, if a meeting is scheduled to end at 9:00 AM, such as the TPM meeting, the system can determine that the communication session has ended when the running time of the communication session is within a threshold time of the end time defined in the calendar item. Thus, the system can determine that the communication has ended when the running time is within, or past, a threshold time, e.g., one minute, of the end time of the communication session. In one example, if the threshold time is one minute, the display of the user interface element describing the one or more properties for the upcoming communication sessions is displayed one minute prior to the end of the communication session. In another example, if the threshold time is zero, the display of the user interface element describing the one or more properties for the upcoming communication sessions is displayed at the end of the communication session.

In another embodiment, the system determines that the communication session has concluded when other attendees leave the communication session. In one example, the system determines that the communication session has concluded when all other attendees leave the communication session (e.g., hung up) except a user, e.g., such as User C 10C receiving a display of the UI 101. In another example, the system determines that the communication session has concluded when a threshold number of other attendees leave the communication session (e.g., hung up) other than a particular user, e.g., such as User C 10C receiving a display of the UI 101. This includes the scenario where a meeting has four other users other than User C 10C, the system determines that the communication session has concluded when three of the four users leave the meeting. This also includes the scenario where a meeting has four other users other than User C 10C, the system determines that the communication session has concluded when a key user, such as a CEO, presenter, or other user having a threshold priority, leaves the meeting. For illustrative purposes, a user that has “left” a meeting, e.g., a communication session, when they have provided an input, e.g., a selection of the “leave” button, for terminating their video and/or audio connection with other participants of the communication session.

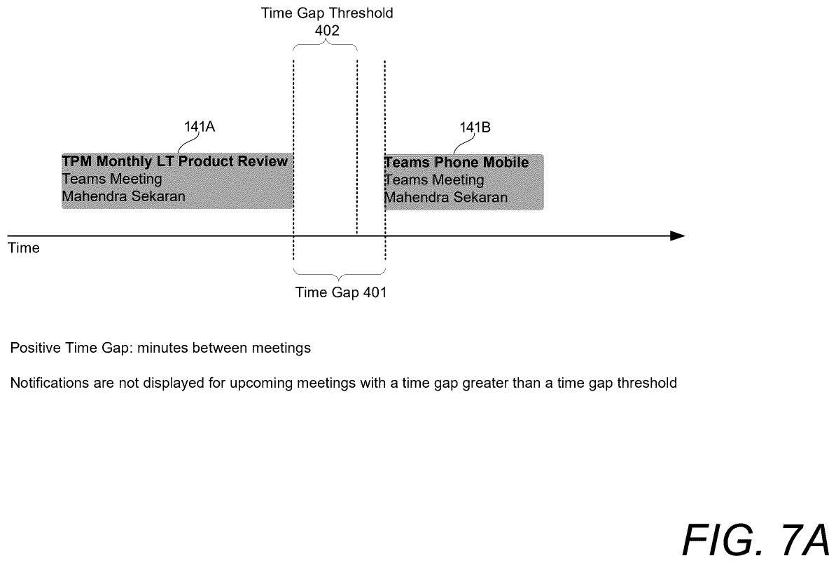

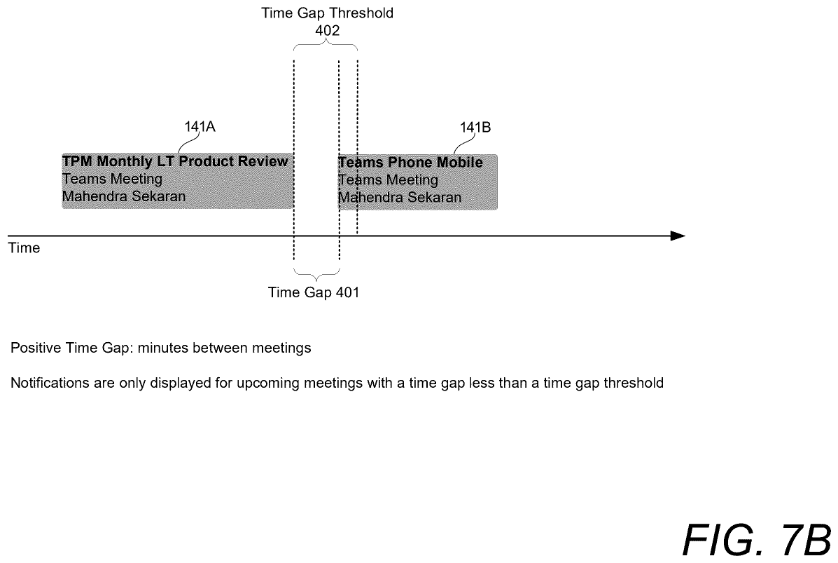

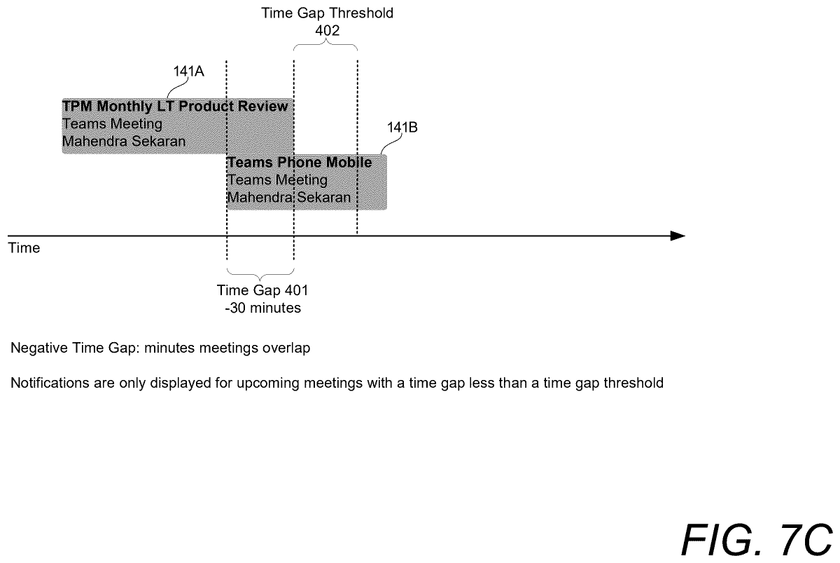

FIG. 2C shows a phase of the process where the system retrieves and displays the information for the meetings that quality as upcoming communication sessions, e.g., adjacent meetings. As shown, in response to determining that the first communication session 141A has ended, is terminated, or has concluded, the system can retrieve one or more properties for upcoming communication sessions 141B-141C having a time gap 401 with the first communication session 141A meeting one or more criteria. This can include retrieving the title, attendee list, user preferences, the user attendance history, the response status, the time proximity, or the recurrence status of the upcoming meetings. As shown in FIG. 2C, the system then displays a user interface element (“notification 120”) describing the one or more properties for upcoming communication sessions having the time gap 401 with the first communication session 141A meeting one or more criteria. As shown in FIG. 7B, the time gap between the two upcoming meetings and the first meeting 141A are within the time gap threshold. This example also shows the title of each meeting and a notification that the user of the computer displaying the UI 101 is also the host of the third meeting 141C. The third upcoming meeting 141C is also ranked higher than the second meeting 141B because the user receiving the notification is also the host of the third meeting 141C and not a host of the second meeting 141B. These rankings of the upcoming meetings can also be based on at least one of user preferences, user attendance history, response status, time proximity, or recurrence status.

FIG. 2D shows a phase of the process where the user provides an input selecting at least one of the upcoming meetings. This phase can include receiving an input indicating a selection of a second communication session 141B from the display of the upcoming communication sessions 141B and 141C. This can be by a voice command, a cursor input, a gesture, or any other suitable input.

FIG. 2E shows a phase of the process where the system concurrently closes the first meeting and adds the person to the selected meeting in response to the selection of the upcoming meeting. In this example, the system terminates communication of at least one of audio signals or video signals of the first communication session between the client device 11C a first set of client devices 11A, 11B, 11D-11F and activates communication of at least one of audio signals or video signals between the client device 11C and a second set of computers 11D-11L of the second communication session in response to the selection of an upcoming meeting, e.g., the second communication session 141B.

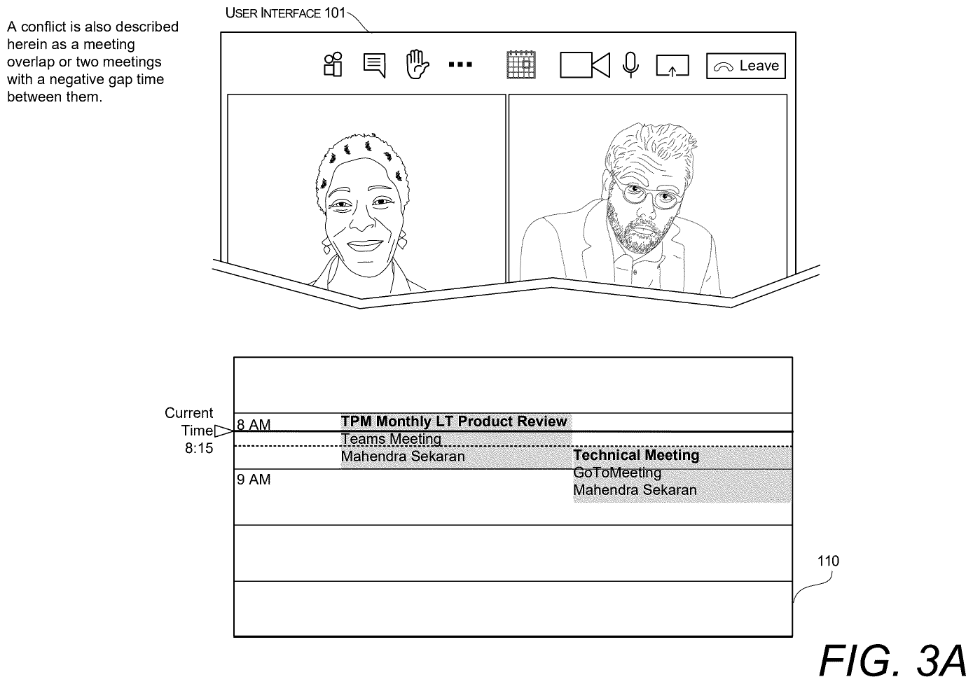

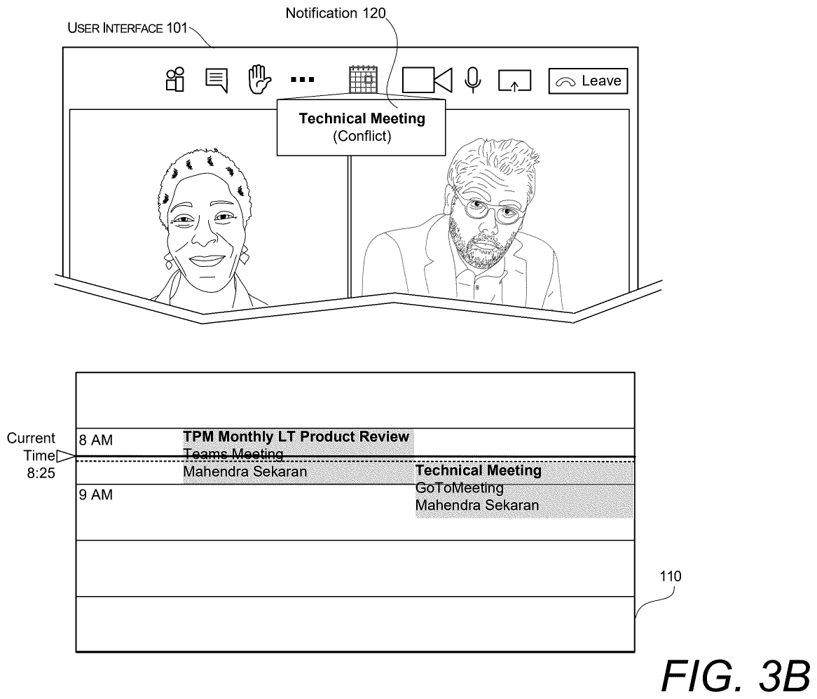

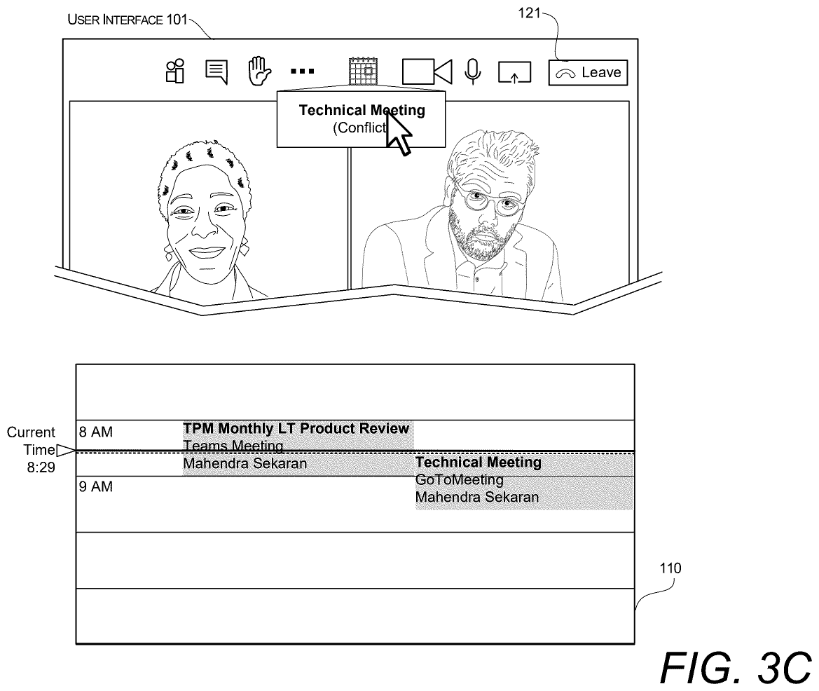

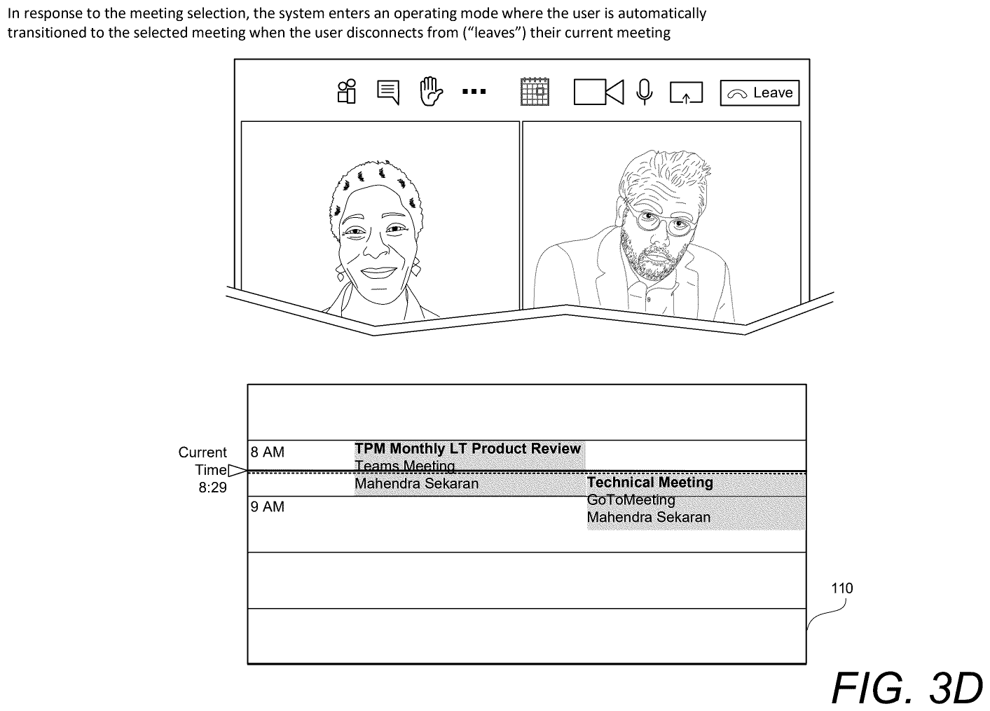

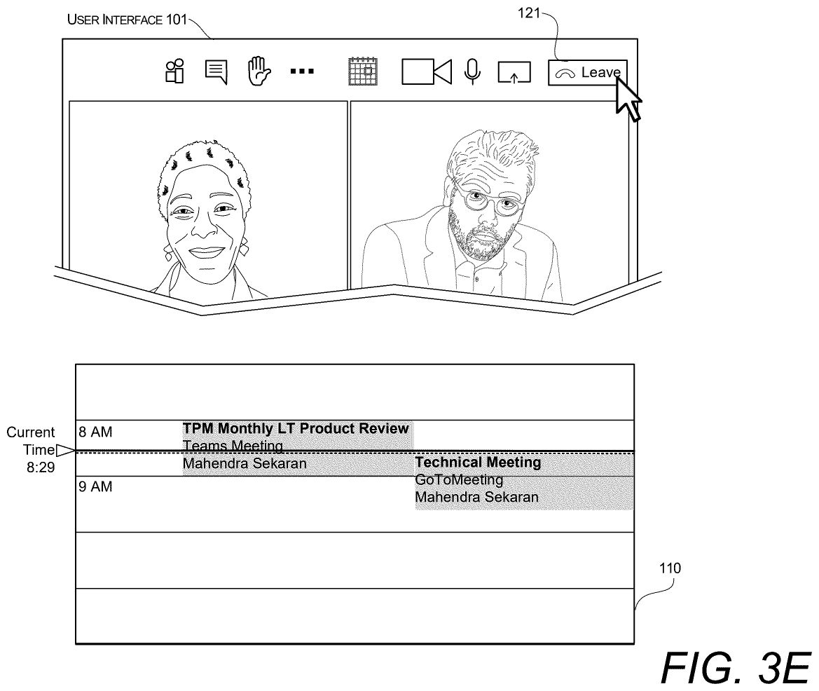

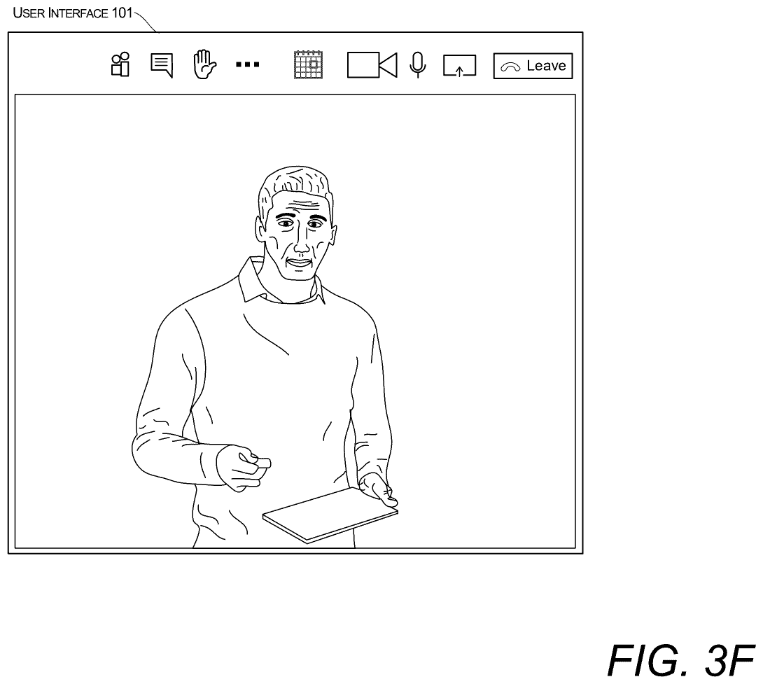

FIGS. 3A-3F illustrate an example system 100 that provides enhanced control and automation of communication session transitions for conflicting meetings. As shown in FIG. 3A, a first meeting “TMP Monthly LT Product Review” is scheduled for 8 AM and lasts for 1 hour, the second meeting “Technical Meeting” is scheduled for 8:30 and lasts 30 minutes. In this example, the second meeting “Technical Meeting” has an end time that is within a threshold of the first meeting, e.g., it is overlapping the first meeting, thus there is no time gap between the meetings, or in other words the time gap between the meetings has a negative value.

During the first meeting, the system analyzes the time, e.g., an elapsed time of a meeting, against the calendar data 110 to determine when a notification should be displayed. The system monitors the time during the first meeting for providing notice before the start of the second meeting. This embodiment does not use the end time of the first meeting if it is determined that the meetings overlap over a threshold. If it is determined that the meetings overlap over a threshold, the system can then analyze an elapsed time during the first meeting to determine that the elapsed time of the first meeting is within a timing threshold of a start time of the second meeting.

The system only displays a notification about the conflicting meeting at a time that is at a time just prior to the start of the second meeting, e.g., two minutes before the second meeting, or within a threshold time of the start of the second meeting. For example, as shown in FIG. 3B, in response to determining that the time gap between the first meeting and the second meeting is below the time gap threshold, e.g., that they are overlapping or adjacent, and in response to determining that the elapsed time of the first meeting is within the timing threshold of the start time of the second meeting, the system causes a display of a user interface element having a notification describing one or more properties of the second meeting. The user interface element includes a selectable control element that causes a transition to the second meeting.

As shown in FIG. 3C, a user input is received at the third client device 11C indicating a selection of one or more upcoming meetings. In response to receiving an input indicating a selection of one or more upcoming meetings, the system enters an operating mode where the computer of the user, such as User C providing the input, is automatically transitioned to the selected meeting when the user provides an input to disconnect from, e.g., “leaves,” their current meeting. This operating mode is shown in FIG. 3D, where the system awaits an input indicating that the user, e.g., User C 10C, is to leave the meeting. In this operating mode, the system automatically disconnects the user from a current communication session and connects the user to a second selected meeting when a leave input command is received from the user. If this operating mode is not activated, the system only disconnects the user from a current communication session when a leave input command is received from the user.

Then, as shown in FIG. 3E, a second input is received where the second input indicates that the third client device 11C is to leave the first meeting. Since the system is in the operating mode described above with respect to FIG. 3D, upon determining that the first communication session has ended, is terminated, or has concluded, e.g., the system automatically closes the current meeting, e.g., disconnect all communication of video and audio streams of the first communication session with the computer of the user. In addition, this second input also causes the system to automatically enter the second meeting, e.g., connect all video and audio streams of the second communication session with the computer of the user. Thus, the leave button can be used for two different functions based on the operating mode of the system. For instance, if the second meeting is not selected at the notification 120 prior to the leave button being pressed, the leave button only terminates the first communication session. However, if the second meeting is selected at the notification 120 prior to the leave button being pressed, the leave button then terminates the first communication session and automatically joins the selected meeting, e.g., the second communication session.

Then, as shown in FIG. 3F, in response to the second input, the system closes the first meeting and automatically joins the user to the second meeting. This transition can include operations for controlling at least one of the audio signals, video signals, and shared content of the first meeting to be restricted from communication between the client computer 11C and the first set of computing devices of the first meeting. The input also controls at least one of audio signals, video signals, and shared content of the second selected meeting to be communicated between the client computer 11C and a second set of computing devices of the second meeting.

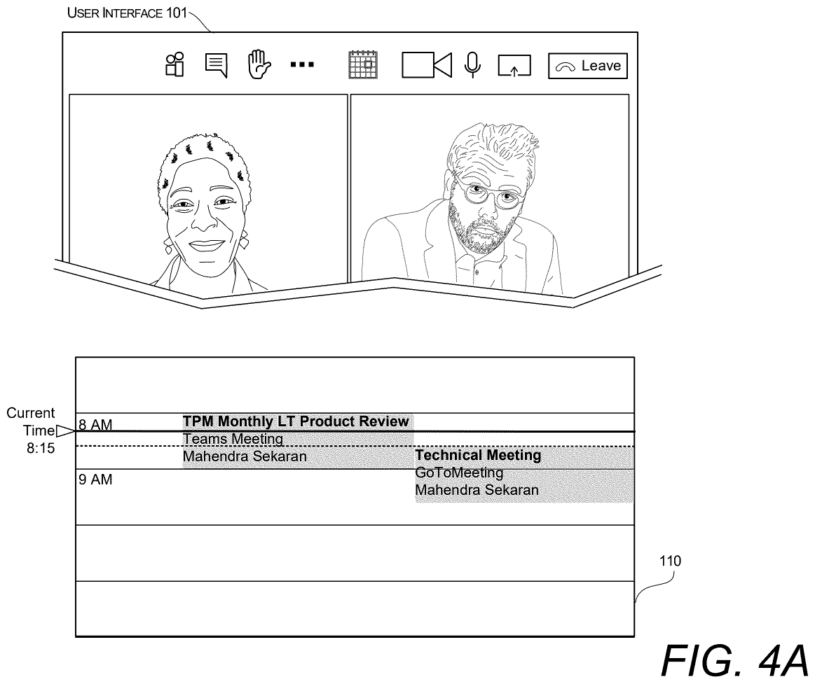

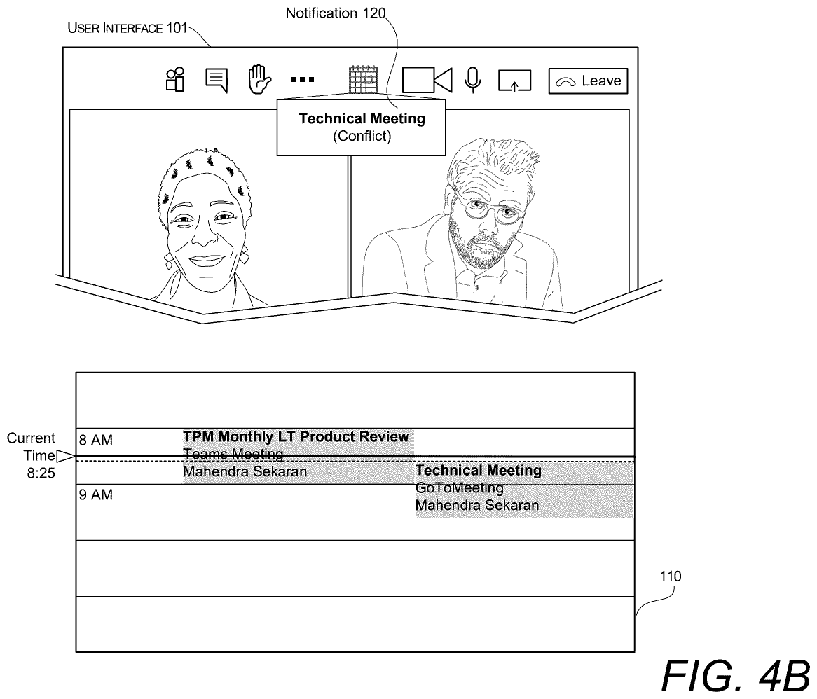

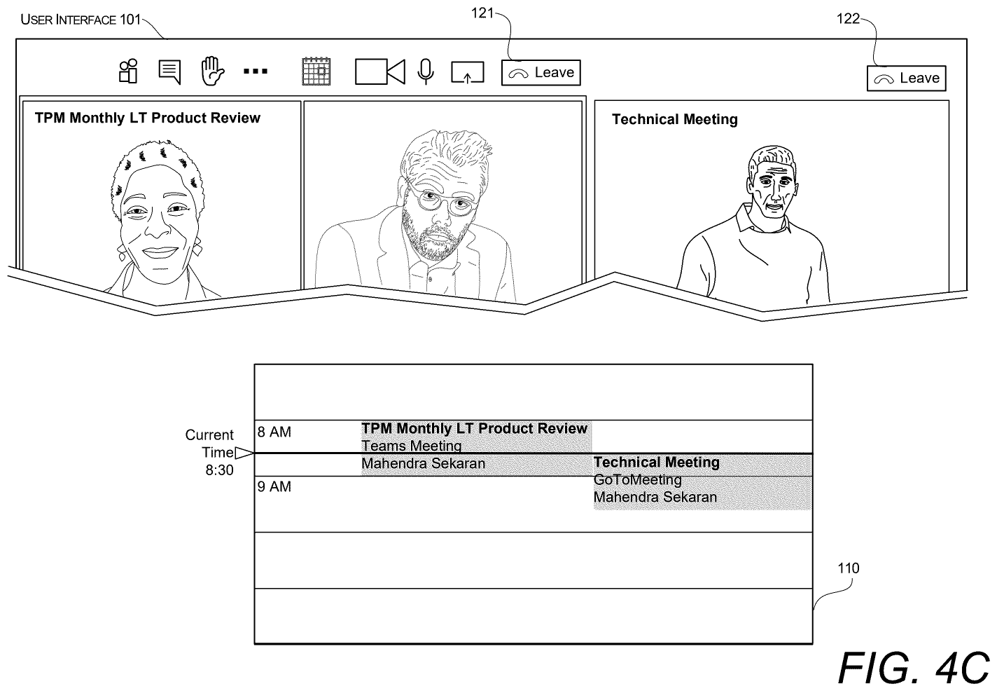

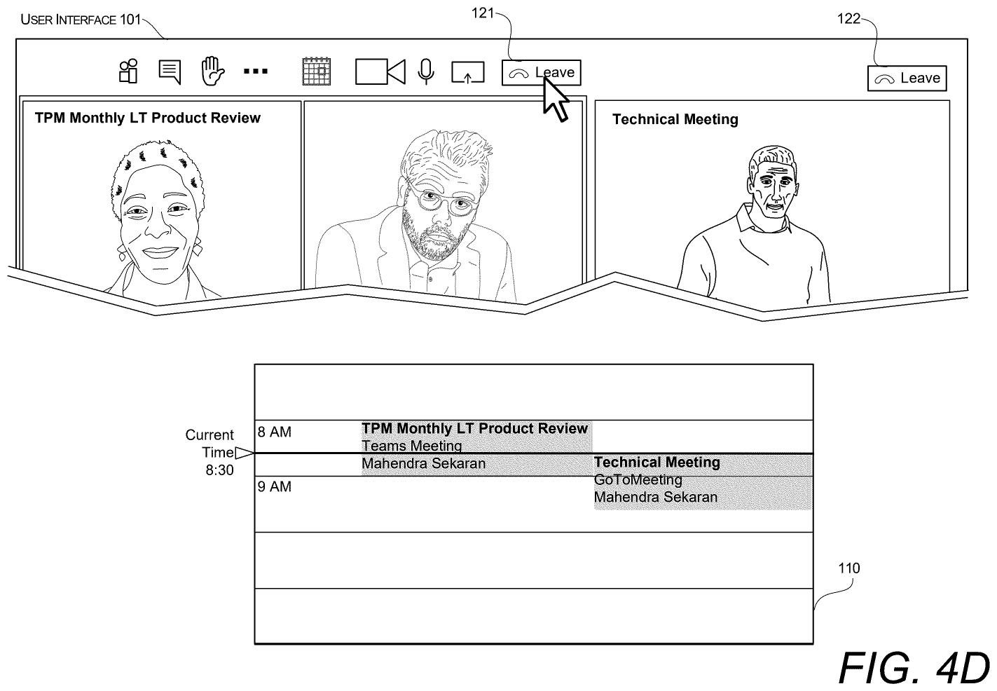

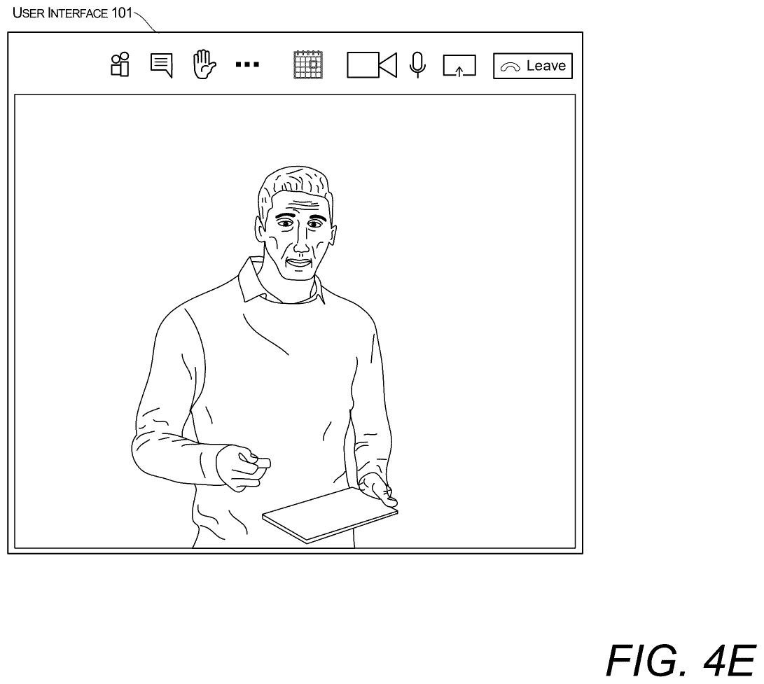

FIGS. 4A-4E show features that can apply to the embodiments described herein where a user can enter a second meeting before leaving a first meeting. FIG. 4A shows an example of a UI displayed on the third computer where a system is in an operating state where an elapsed time of a meeting is monitored to determine if a notification is to be displayed regarding a conflicting meeting. In this state, the notification is not shown as the elapsed time does not meet one or more conditions. FIG. 4B shows the system in an operating state where an elapsed time meets a condition with respect to one or more thresholds to issue a notification regarding a conflicting or adjacent meeting. In FIG. 4C, the system enters the interim operating state where the computer of a user enters a second meeting, e.g., an adjacent or overlapping meeting, before exiting a first meeting. This user interface arrangement can be displayed in response to any of the phases described above. For example, this user interface arrangement can be displayed in response to a user input to leave a meeting, as descried above with respect to FIG. 1E. In another example, this user interface arrangement can be displayed in response to the second user input shown in FIG. 2D. This user interface arrangement includes the display of both meetings concurrently. In other embodiments, the user interface arrangement can include either the display of videos and/or connection of audio from either meeting or none of the videos from either meeting and only audio of either or both meetings. FIG. 4D shows the computer in the interim operating state where the computer of a user is in a second meeting and a first meeting, and the user or another computer provides an input to for the user to leave either meeting, such as the first meeting. Upon this additional input the user disconnects from the first meeting. FIG. 4E shows another operating state where the user enters the second meeting and after they have left the first meeting from the user interface arrangement of FIG. 4D showing leave buttons for both meetings.

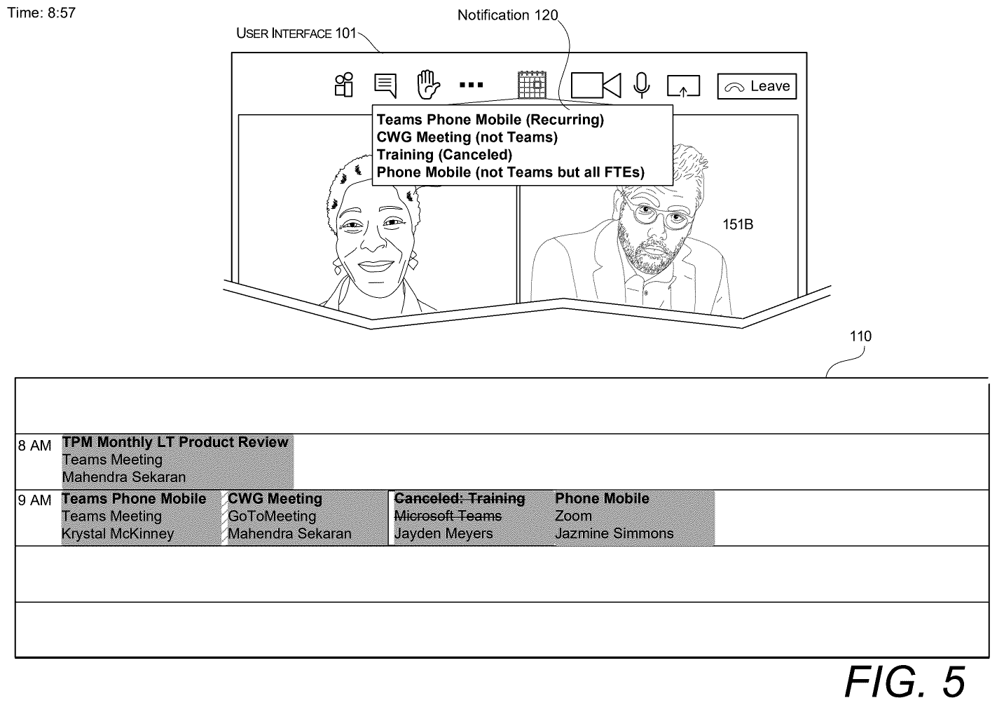

Referring now to FIG. 5, the embodiments disclosed herein can display a notification that has a prioritized list of upcoming events. This prioritized list also provides additional characteristics of each upcoming event to help a selection of one or more events for the user to join. In general, the order of the prioritized list of the upcoming events and/or the automatic selection of one or more events can be based on one or more factors, including but not limited to: a meeting type, communication platform, meeting status, invitees of a meeting, attendees of a meeting, shared content of a meeting, and/or data defining user behavior. Factors involving an invitee or an attendee can include at least one of a title of a person, a role of a person, a title of a person, or an organizational characteristic of a person, e.g., if they on the same team as the user, on the same project as the user, listed in a document with the user, etc. As shown, any type of characteristic of a meeting can be displayed on the notification 120, such as a meeting status, characteristics of an attendee or invitee, whether a meeting is recurring, etc.

In one illustrative example, consider an example where a user preference file of the third user 10C indicates that they prefer to have a notification of an upcoming or conflicting meetings at least three minutes prior to the upcoming or conflicting meeting. In scenario shown in FIG. 5, at 8:57, the system determines that there is three minutes till the end of the first meeting, the “TPM Monthly LT Product Review.” When such a condition is met, and when the system determines that the next set of meetings are within a time gap threshold of the first meeting, the system displays a prioritized list of the upcoming events in the notification 120. In this example, the user interface 101 is displayed on the computing device 11C of User C 10C.

The user preference file can also indicate policies to indicate their priorities for different types of meetings. For instance, a user, such as the third user 10C, can indicate that their top priority includes meetings that they organized. Thus, of the four upcoming meetings, Teams Phone Mobile, CWG Meeting, Training, and the Phone Mobile meeting; the system prioritizes the Teams Phone Mobile meeting that is organized by the third user, Krystal Mckinney, at the top of the list. A similar priority or a secondary priority can be given for meetings that were created by people on their same team, their same company, etc. Thus, if Jazmine is on the same team as Krystal, that meeting would be ranked second.

A high or low priority can be given for meetings having a certain status. For example, when an upcoming meeting has a “canceled” status, that meeting may be ranked lower than meetings that are not canceled. But such meetings can also be ranked higher than other meetings, e.g., meetings that are organized by individuals outside of a company or team. The meeting status can also include the response status for the user. For instance, if User C responded to a meeting invitation with an “Accept” response, that meeting will be ranked higher than a meeting where User C responded with a “Tentative” or “Declined” response. Similarly, if User C responded to a meeting invitation with a “Tentative” response, that meeting will be ranked higher than a meeting where User C responded with a “Declined” response. For instance, as shown in FIG. 5, the system can rank the CWG meeting below the Teams Phone Mobile meeting since the user responded with a Tentative for the CWG meeting versus an accept for the Teams Phone Mobile.

The user preference file can also indicate other policies for other priorities that are based on a platform type. For instance, a priority can be given based on a meeting that uses the Microsoft TEAMS application for managing the communication sessions. A priority for Microsoft Teams can be higher than other platforms such as GoToMeeting, Zoom, etc. Thus, as shown in the example of FIG. 5, the system can select the Teams Phone Mobile meeting first since it is managed by the Teams system vs, the other meetings which are not Teams.

In an example using a person's historical record defining user behavior, a higher priority is assigned to meetings that include attendees or invitees who are listed in a person's historical record. For instance, if the third user, Krystal Mckinney, has a history of having previous meetings with Mahendra, and no past meetings with Jayden, the system would rank Mahendra's meeting higher than Jayden's meeting. The system also analyzes and compares historical patterns to determine the rank of one or more meetings. For instance, if the third user, Krystal Mckinney, has a history of having over 50 meetings with Mahendra, and only 12 past meetings with Jayden, the system would rank Mahendra's meeting higher than Jayden's meeting. Such factors can also use other historical data. For instance, if the third user is listed in a number of shared documents with Mahendra more than Jayden, system would rank Mahendra's meeting higher than Jayden's meeting. This can also apply to a number of different types of events and occurrences, such as a volume of messages in a thread with another user, a number of phone calls, etc.

In an example using organizational data and characteristics of attendees or invitees, a higher priority is assigned to meetings having predetermined attendees or invitees. For instance, if an upcoming meeting includes teammates or people from a specific department, or people having a particular rank or title within accompany, that particular meeting would be ranked higher over other meetings they do not include those invites, or include fewer numbers of those particular invites or attendees or people who are not in the same company, department, team, etc. This also applies to titles and roles of attendees and invitees. For instance, a meeting that includes a CEO would rank higher than a meeting that includes mid-level managers.

In an example using calendar data, such as a meeting type, a higher priority or a lower priority is assigned to meetings having a predetermined meeting type. For instance, the third user can have a preference indicating a priority for meetings that are not recurring meetings, versus meetings that are recurring. Thus, a notification can list non-recurring meetings as a higher priority over meetings that are recurring meetings. In other embodiments, a recurrence status can also increase the priority of a recurring meeting versus meetings that are not recurring. In such embodiments, a notification can list recurring meetings as a higher priority over meetings that are not recurring meetings.

In another example, the third user can have a preference indicating a priority for group meetings versus company-wide meetings. In such an instance, the ranking of the group meeting would be ranked higher than the company-wide meeting. This ranking can also be based on a number of attendees. For instance, if a first meeting has less than the threshold number of attendees, and a second meeting has above the threshold number of attendees, the system would rank the first meeting above the second meeting. The rank of a meeting can be influenced based on the permissions as well. For instance, a first meeting may be ranked higher or lower than a second meeting if the communication format for the first meeting is set for a single presenter having rights to broadcast video and audio and all audience members are only set to receive only, versus a second meeting where each person can send and receive audio signals, e.g., a small group meeting.

In an example using characteristics of shared content in a meeting, a higher priority is assigned to meetings having particular characteristics, quantity, or ownership of shared content. In one example, a meeting might be ranked higher if shared content within that meeting contains subject matter that is listed in a user preference file; versus another meeting that has content having a different subject. A quantity of content, or a particular format of shared content may also rank a meeting higher than other meetings that do not include that particular quantity of content or a particular format of shared content.

All of these factors can also be scored individually, and also weighted, to determine an overall score for each meeting. This allows a system to select and/or rank meetings based on a number of factors. For instance, consider the following example table that includes a number of different factors. Some of these factors that have a higher score, can also be listed in the notification. For instance, if a meeting has shared content that has subject matter that is of interest to a particular user, in addition to the subject matter influencing, the ranking of the meeting, the notification would list the subject matter and nature of the shared content.

TABLE 1
First Example Ranking of meetings Based on Multiple Factors

| | | Meeting | Platform | FTE | |
|---|---|---|---|---|---|
| Meetings | My Role | Status | Type | External | Rank |
| First Meeting | 10 | 10 | 10 | 10 | 1 |
| Second Meeting | 1 | 10 | 2 | 10 | 2 |
| Third Meeting | 1 | 0 | 10 | 10 | 3 |
| Fourth Meeting | 1 | 10 | 2 | 0 | 4 |

The rankings for the meetings of TABLE 1 can result from a scenario where the meetings have the properties described above with respect to FIG. 5. Each meeting is ranked based on a sum of score components representing each factor. For example, the first column shows a score component for the role of the user, e.g., the third user of the third computer, for each meeting. In this example, the third user is the organizer of the first meeting, thus the score component for the user's role is correspondingly high for that meeting. The other meetings are correspondingly lower for the score component for the user's role, since the third user is not the organizer in those meetings.

Each meeting also has a score component for the meeting status. Since the first, second and fourth meetings are active, e.g., not canceled, that score component for those meetings is correspondingly high. Since the third meeting is canceled, that score component for the meeting status is correspondingly lower. For the platform type, the first and third meetings have a score component for the platform type that is correspondingly high since they are on the Teams platform. The other meetings are correspondingly lower for the score component for the platform type since those meetings are on other types of platforms. For the fourth category, membership type, the first, second and third meetings have a score component for the membership type that is correspondingly high since they all have full time employee (FTE) members. The fourth meeting is correspondingly lower for the score component for the membership type since that meeting includes members who are not in the same company.

These score components can also be weighted to emphasize certain properties. For instance, it may be more important for a person to make sure that a meeting they host, or a meeting where they are listed as a presenter, be ranked high on a list. Thus, a higher weight can be multiplied by that score component, and a lower weight can be combined with other factors, to ensure that the role of the user is considered first in any ranking. Also shown in FIG. 5, the notification 120 can also show any property of the ranked meetings. In this example, the first meeting is displayed as a recurring meeting, the second meeting indicates that an external platform is used, the third meeting is displayed as canceled, and the fourth meeting is shown as including attendees who are external to the company. When an upcoming meeting or a group of upcoming meetings meet one or more thresholds with respect to the ranking or a priority score, these detected conditions can be used to transition a computer to any of the operating modes or operating states described herein.

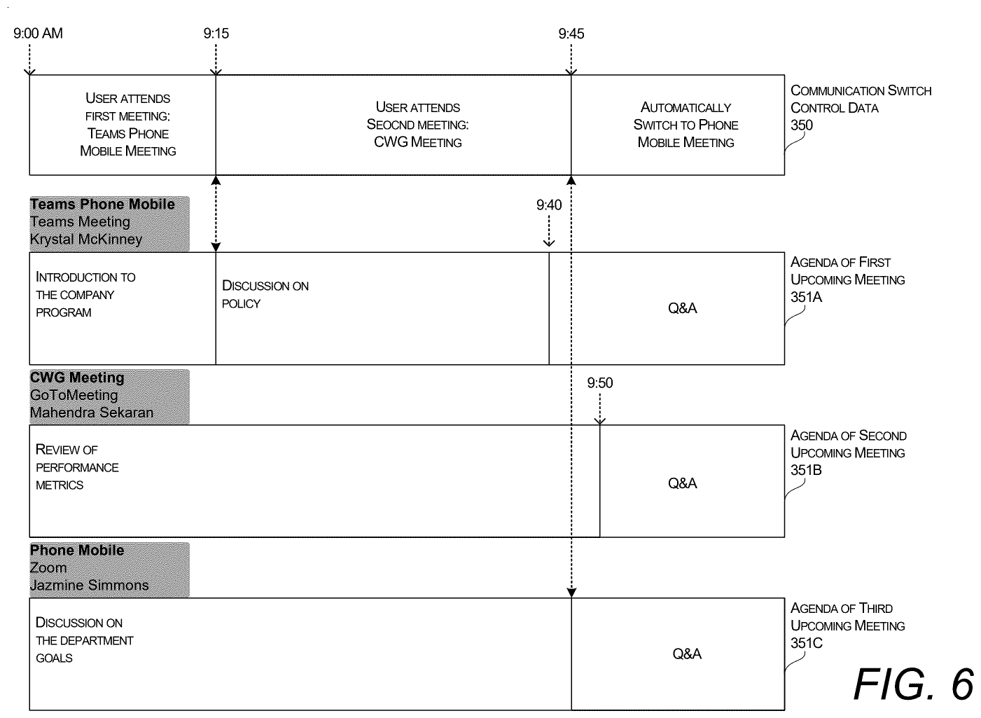

Referring now to FIG. 6, aspects of an embodiment where a system can switch back and forth between conflicting meetings. Instead of selecting one upcoming meeting, the user or the system can select more than one meeting control a user interface and allow a person to attend individual sections of different meetings and the system switched between the meetings based on the detection of predetermined activity in the meetings. For example, the user can attend the first section of a first meeting, a second section of a second meeting, and third section of a third meeting. The transitions between the different meeting sections can be based on a user input control or the transitions can be automatically controlled by the system using the agendas or activity of the meetings. In the example shown in FIG. 6, in the first meeting, the introduction may last 15 minutes up 9:15, then a section of the first meeting includes a discussion on policy up to a Q&A session starting at 9:40. In the second meeting, the review of performance metrics starts at 9 and lasts till a Q&A session starting at 9:50. In the third meeting, the discussion of the department goals starts at 9 and lasts till a Q&A session starting at 9:45.

Based on a selection of the meeting sections, the system can switch between the meetings and allow the user to attend sections of their preference. The selected meetings sections can be based on the factors disclosed herein including but not limited to historical records on a user's interests and behavior. In this example, the user has a preference for attending the introduction of the subject matter, e.g., the subject of the first meeting from 9:00 to 9:15, then the system can generate control data to cause the computer of that user to connect to that meeting when the use leaves another meeting or when a meeting they are attending terminates. The generate control data can also cause that person's computer to transition to other select sections of different meetings, e.g., the policy discussion of the second meeting, and a Q&A session on the performance metrics meeting. When the system determines that the Q&A session on the performance metrics is a higher priority over the other Q&A sessions, the system only transitions to the Q&A session of the third meeting when that Q&A session is scheduled to start, e.g., 9:45 AM, or when that Q&A session actually starts. The meeting sections can be selected using any of the ranking techniques disclosed herein, including, but not limited to, the use of attendee lists, user activity, historical records, etc. Thus, in another example, a user can have a schedule as outlined in FIG. 6, where the system switches between different sections of different meetings according to an agenda or according to specific shared content, however the system can also be configured to automatically switch to a meeting where a specific person starts to speak. In such an example, the system can automatically switch to a meeting where a CEO starts to speak, when a person talks about a specific subject, or when specific content is shared.

FIGS. 7A-7C show examples of how a time gap threshold is used in a process for determining when and/or if a notification should be displayed. For example, FIG. 7A shows an example of how an event of a calendar does not meet one or more conditions with respect to a time gap threshold. A positive time gap, e.g., 30 minutes, is greater than the time gap threshold, e.g., 15 minutes. FIG. 7B shows an example of how an event of a calendar meets one or more conditions with respect to a time gap threshold. A positive time gap, e.g., 10 minutes, is less than the time gap threshold, e.g., 15 minutes. FIG. 7C shows an example of how an event of a calendar having a negative time gap meets one or more conditions with respect to a time gap threshold. A negative time gap, e.g., the meetings overlap by 15 minutes (−15 minute time gap), is less than the time gap threshold, e.g., 15 minutes.

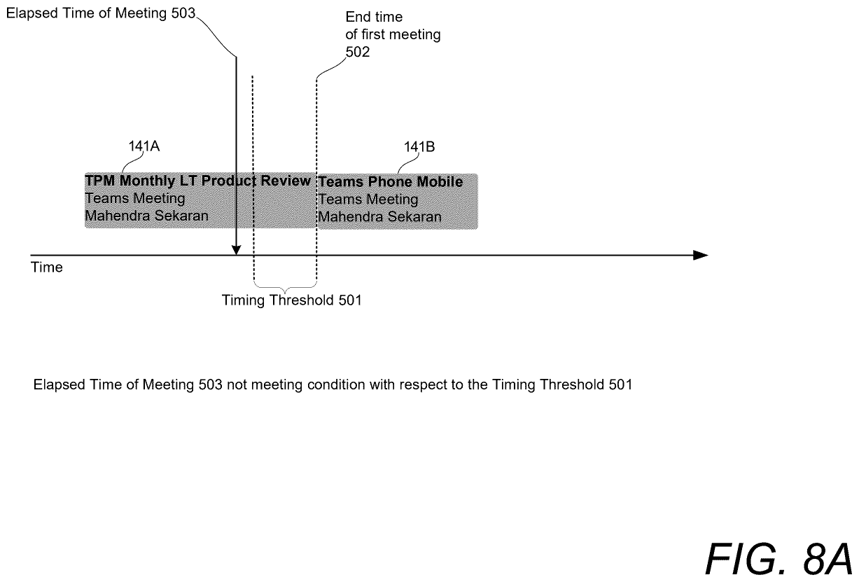

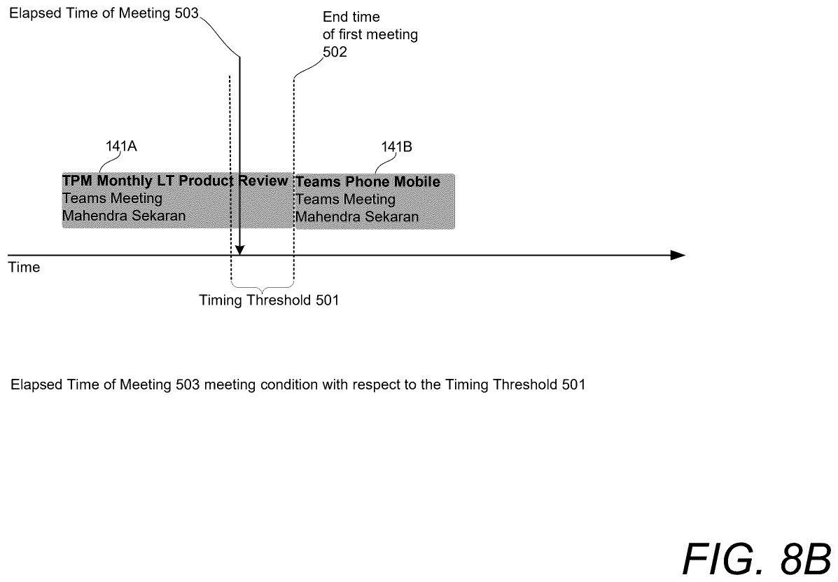

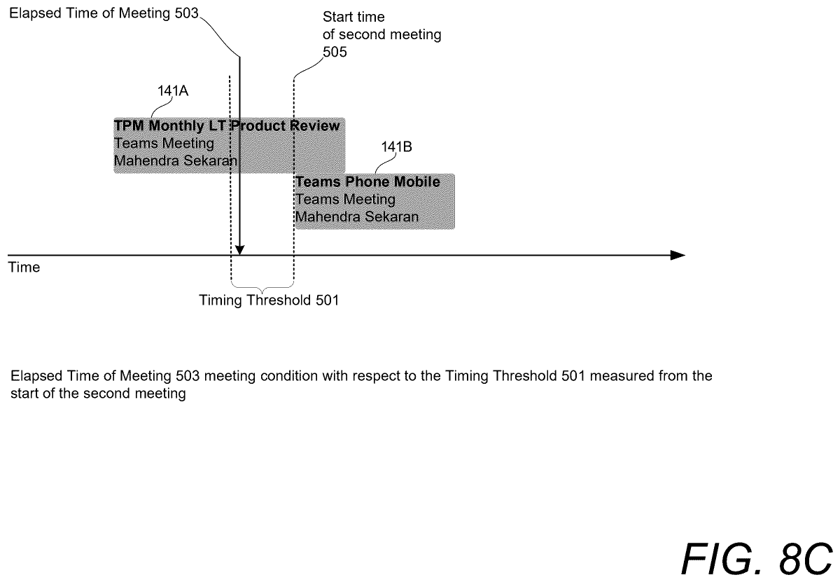

FIGS. 6A and 6B show examples of how a running time (elapsed time) of a meeting is used in a process for determining when and/or if a notification should be displayed. FIG. 8A shows an example of how an event of a calendar does not meet one or more conditions with respect to a timing threshold. During the first meeting, if the current time (elapsed time 503) of the meeting is more than the timing threshold from the end 502 of the first meeting, the system does not display the notification. In another embodiment, if the current time of the meeting is more than the timing threshold from the start of the second meeting, the system does not display the notification. FIG. 8B, shows an example of how an event of a calendar meets one or more conditions with respect to a timing threshold. During the first meeting, if the current time 503 of the meeting is less than the timing threshold from the end of the first meeting 502, the system displays the notification. In another embodiment, if the current time of the meeting is less than the timing threshold from the start of the second meeting, the system displays the notification. These conditions can be combined with other conditions defined herein to control the timing of the notification 120. FIG. 8C shows an example of how an overlapping event of a calendar meets one or more conditions with respect to a timing threshold.

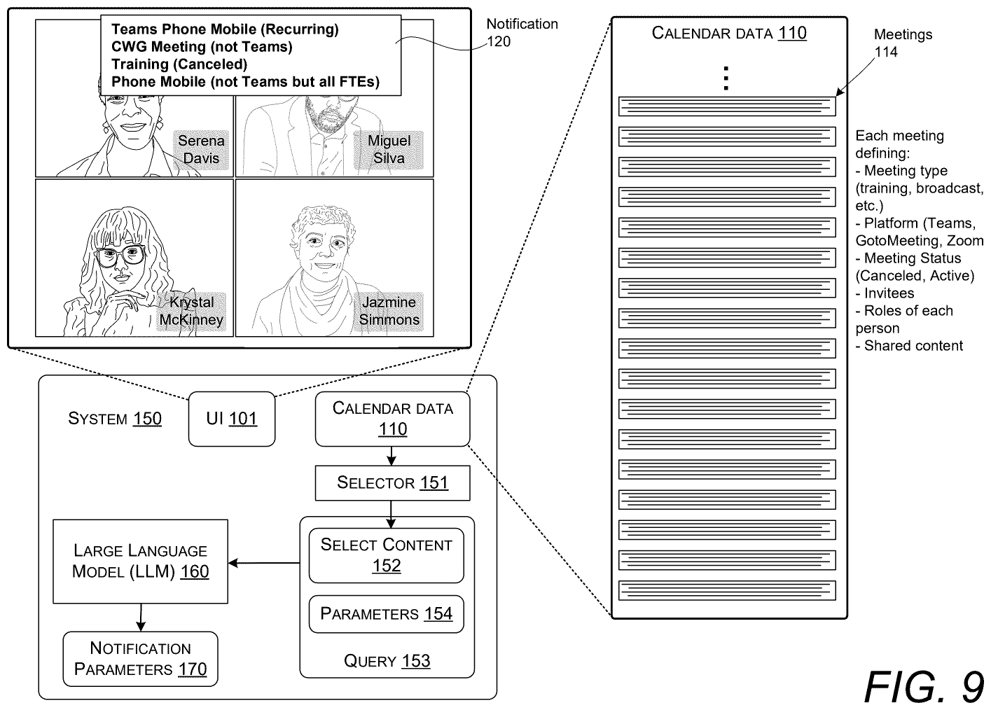

As shown in FIG. 9, the system can also utilize an AI model, such as a large language model, to determine parameters for the notifications. The parameters can include rankings for upcoming meetings or conflicting meetings and also select meeting characteristics to display on a notification. For example, if a user has two upcoming meetings with two different groups of people, the system can analyze that person's past meanings to determine the people in each group that they met in the past. Based on one or more metrics, e.g., how many times the user met with each person in the past or how many times the user declined meetings from certain people in the past, the system can determine a rank for upcoming meetings.

Thus, in this example, the system may rank the first meeting over the second because the first meeting includes invitees that the person has met with more frequently over the invitees of the second meeting. These decisions can also be based on title or roles of each of the attendees and also shared content. As described in more detail herein, historical attendance and metadata related to each meeting can be sent to an AI model for training data and or queries for determining a priority of any upcoming meetings.

As described in more detail below, any combination of the factors described herein can be used in this model with the use of a query, query parameters, and select content that is derived from calendar data. FIG. 9 shows a system 150 that can be used to rank and/or select upcoming meetings using a large language model 160. This embodiment includes a selector module 151 that can be used to identify calendar data 110 to use as grounding data for the LLM 160. The selector module identifies portions of the calendar data 110 based on the activity of the meeting participants. For example, the selector may identify each meeting that includes the third user, e.g., the user operating the computer that is to display the notification. The select content can include meetings having characteristics pertaining to the user's profile or historical behavior, include a Meeting type (training, broadcast, one-on-one, department group session, etc.), a Platform type, (Teams, GotoMeeting, Zoom), a Meeting Status (Canceled, Active), Invitees, Roles of each person, and Shared content. Once the select content 152, e.g., selected meetings involving predetermined, activity, content and/or people, are determined, the system can generate one or queries 153 and query parameters 154 to send to the LLM 160 with the select content 152. The select content can also include the upcoming meetings and all of the data defining the characteristics of those meetings, e.g., the invitees, the shared content, a time, date, the platform, a meeting status, etc.

The parameters of the queries can include user preferences and specific questions regarding one or more of the factors described herein. For example, a query parameter can include a phrase, such as “determine a rank for each of the upcoming meetings based on the relationship between the shared content of the upcoming meetings and content that User C has worked on for the last two weeks.” This type of query would influence the system to bring highlight or emphasis to meetings that pertain to our current project or projects having a high priority. In another example, a query parameter can include a phrase, such as “determine a rank for each of the upcoming meetings based on the relationship between the shared content of the upcoming meetings and content that User C has shared in previous meetings, but also give priority to upcoming meetings that User C is a host or a presenter.” This type of query would influence the system to give priority to meetings that have shared content that is related to content that User C has shared in past meetings, while also giving priority to upcoming meetings is hosting or is listed as a presenter. These examples are for illustrative purposes and are not to be construed as limiting, as the queries generated by the system use calendar data defining past meetings and future meetings are configured to cause the LLM to use any combination of factors to rank and/or select upcoming meetings that pertain to one or more preferences of a user.

In one illustrative example, the system can generate a prompt that identifies calendar events that are dated prior to a predetermined date as grounding data for the large language model and identifies calendar events that are after the predetermined date as current events to be ranked. The query can cause the large language model to use the grounding data to identify historical patterns for a particular user and identify one or more of the current events that meet one or our criteria with respect to the historical patterns. The system can then cause the large language model to rank and/or select the current events that meet that meet the one or our criteria with respect to the historical patterns. The queries can also include exceptions. For instance, a query may include a phrase that causes the LLM to select an upcoming meeting with shared content that is of interest to a user, but override that selection and select meetings that are hosted by the user as a top priority meeting.

The queries can also be used to determine permissions and settings for past meetings to determine permissions and settings for upcoming meetings. For instance, a query can identify permissions and settings for past meetings having a particular set of invitees, and then cause the LLM to determine permissions and settings for future meetings based on the invitees of those future meetings. This can allow the LLM to modify permissions and settings for each invitee in future meetings based on what each user had in the past. Descriptions of these permissions and settings can be provided in the notification for the user to approve before a transition to a future meeting.

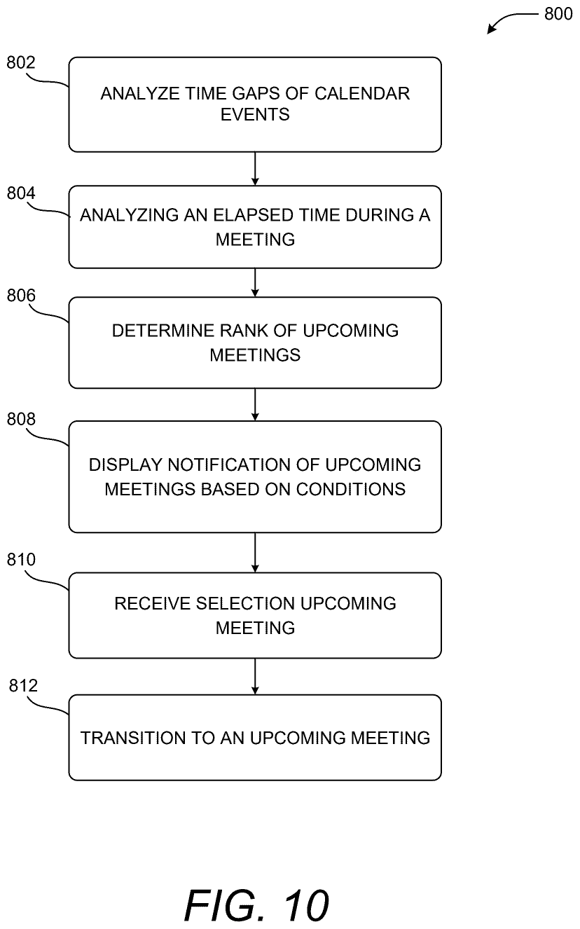

Turning now to FIG. 10, aspects of a routine 800 that causes a generation of a notification for providing notice and control of upcoming meetings are shown and described below. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can end at any time and need not be performed in its entirety. Some or all operations of the methods, and/or substantially equivalent operations, can be performed by execution of computer-readable instructions included on a computer-storage media and computer-readable media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

For example, the operations of the routine are described herein as being implemented, at least in part, by an application, component and/or circuit, such as a device module that can be included in any one of the memory components disclosed herein, including but not limited to RAM. In some configurations, the device module can be a dynamically linked library (DLL), a statically linked library, functionality enabled by an application programing interface (API), a compiled program, an interpreted program, a script or any other executable set of instructions. Data, such as input data or a signal from a sensor, received by the device module can be stored in a data structure in one or more memory components. The data can be retrieved from the data structure by addressing links or references to the data structure.

Although the following illustration refers to the components depicted in the present application, it can be appreciated that the operations of the routine may be also implemented in many other ways. For example, the routine may be implemented, at least in part, by a processor or circuit of another remote computer (which can be a server) or a local processor or circuit of a local computer (which can be a client device receiving a message or a client device sending the message). Any aspect of the routine, which can include the generation of a prompt, communication of any of the messages with the prompt to an NLP algorithm, use of an NLP algorithm, or a display of a result generated by an NLP algorithm, can be performed on either a device sending a message, a device receiving a message, or on a server managing communication of the messages for a thread. In addition, one or more of the operations of the routine may alternatively or additionally be implemented, at least in part, by a chipset working alone or in conjunction with other software modules. Any service, circuit or application suitable for providing input data indicating the state of any device may be used in operations described herein.

The routine starts at operation 802 where the system analyzes time gaps of calendar events to determine if the calendar events meet or more criteria. In operation 802 the system can cause an analysis of calendar data to determine that a time gap between a first communication session and a second communication session is below a time gap threshold. This analysis of calendar events is to determine if they are adjacent, e.g., within a threshold time of one another. The analysis of the calendar can be done before or during a meeting. This analysis can include overlapping meetings, which in that situation, the time gap is negative and less than the time gap threshold.

At operation 804, the system analyzes an elapsed time during a meeting, such as the first meeting. Operation 804 can include monitoring the running time during the first meeting for providing notice near the end of the meeting or a time just prior to a start time of a conflicting or adjacent meeting. In one example, such operations can include analyzing an elapsed time during the first communication session to determine that the elapsed time of the first communication session is within a timing threshold of an end time of the first communication session. In another example, such operations can include analyzing an elapsed time during the first communication session to determine that the elapsed time of the first communication session is within a timing threshold of a start time of a second communication session.

At operation 806, the system determines a rank for upcoming meetings. When multiple meetings meet one or more criteria for qualifying as an adjacent meeting, the system can determine a rank for those particular meetings. The rank can be based on one or more characteristics of the upcoming meetings, e.g., identities of invitees, roles and permissions of invitees, shared content, etc. In some configurations, the system can utilize an AI model to determine a rank for each of the upcoming meetings and also select meetings that cause the system to automatically join those specific meetings. This system can automatically cause the transition to a selected meeting after displaying the selected meeting in a notification to the user.

At operation 808, the system can display the notification in response to the detection of one or more fulfilled criteria. For example, the display of a user interface element having a notification describing one or more properties of the second communication session or a ranked listed of upcoming meetings, in response to determining that the time gap between the first communication session and the second communication session is below the time gap threshold, and in response to determining that the elapsed time of the first communication session is within the timing threshold of the end time of the communication session. In some embodiments, the user interface element includes a selectable control element that causes a transition to the second communication session. Thus, a user can provide an input to confirm the recommendation of a ranked meeting at the selectable control element and cause the transition to the second communication session or a selected communication session from a list. The properties of each communication session can include at least one of a title of a meeting, a start time of a meeting, an end time of a meeting, content shared for a meeting, a recurring status, attendee list, attendee status, invitee list, invitee response status (tentative, accepted, rejected), titles of each invitee, etc.

One illustrative example of fulfilled criteria can include: when the meeting has ended (based on an end time), display the automatic “UI prompt to join next back-to-back meeting.” This can include operations for determining that the first communication has ended comprises: analyzing a calendar item defining the first communication session to determine that a running time of the first communication session is within a threshold time of an end time of the first communication session or a current time has passed the end time, wherein the display of the user interface element describing the one or more properties for the upcoming communication sessions is displayed in response to determining that the running time of the first communication session is within the threshold time of the end time of the first communication session or the current time has passed the end time.

Another illustrative example of fulfilled criteria can include: when the meeting is terminated, e.g., user selects the “leave button,” the system displays the automatic “UI prompt to join next back-to-back meeting.” This can include operations for determining that the first communication is terminated comprises: receiving an input for terminating the first communication session, wherein the display of the user interface element describing the one or more properties for the upcoming communication sessions is displayed in response to receiving the input for terminating the first communication session.

Yet another illustrative example of fulfilled criteria can include: when the meeting has concluded, e.g., when a threshold number of users have “hung up” the meeting, the system displays the automatic “UI prompt to join next back-to-back meeting.” This can include operations for determining that the first communication has concluded comprises: analyzing communication data to determine that a threshold number of users have left the first communication session, wherein the display of the user interface element describing the one or more properties for the upcoming communication sessions is displayed in response to determining that the threshold number of users have left the first communication. This example can also include a scenario where if a meeting has concluded, e.g., when all other attendees already hung up or left the meeting except for the user (User 10C), the system displays the automatic “UI prompt to join next back-to-back meeting. This can include operations for determining that the first communication has concluded comprises: analyzing communication data to determine that all other users have left the first communication session except for a predetermined user (10C), wherein the display of the user interface element describing the one or more properties for the upcoming communication sessions is displayed in response to determining that all other users have left the first communication session except for a predetermined user (10C).

At operation 810, the system receives an input from the user. This input can be in response to a user selectable element displayed on a user interface. In other embodiments, the input can be provided by a voice input captured by a microphone or an input gesture captured by a camera or sensor.

At operation 812, in response to receiving the input at the selectable control element that causes the transition to the second communication session, controlling at least one of audio signals, video signals, and shared content of the second communication session to the computing device associated with the received input. Operation 812 can include activating a communication session between a computer, such as the third computer, to allow receipt and transmission of audio, video and shared content from and to other members of the communication session. This operation can also include closing a session for the first meeting and opening a session for the second meeting. This can include restricting all communication of any type of data to the members of the first communication session. The input can also be in the form of a voice command, a touch screen command, a movement gesture, etc.

The operations of the routine can include operations for controlling transitions between communication sessions. For example, FIGS. 1A-1D show examples where UI prompt can be automatically displayed providing notice that a user is to join a next back-to-back meeting, or a prioritized meeting among many scheduled at the same time slot. Then, when the user leaves the meeting they are attending, the system automatically transitions to the second meeting. To achieve this, FIG. 7B shows a system performing an analysis of events to determine if they are adjacent (“back-to-back”), e.g., within a threshold time of one another. This allows the system to only display a notification when such meetings are sequenced within a short period of time. The time gap can be a positive number (30 minutes apart), zero (adjacent), or a negative number (overlapping). These operations include causing an analysis of calendar data (110) to determine that a time gap (401) between a first communication session 141A and a second communication session (141B) is less than a time gap threshold 402.

FIG. 8B shows an example where a system monitors the time during the first meeting for providing notice near the end of the meeting. This includes operations for analyzing an elapsed time (503) during the first communication session (141A) to determine that the elapsed time (503) of the first communication session (141A) is within a timing threshold (501) of an end time (502) of the first communication session (141A). FIGS. 1B & 4B show an example where analyzes conditions so the system only displays a notification about the adjacent meeting near the end of the first meeting, e.g., last two minutes in the first meeting. These operations can include causing a display of a user interface element displaying a notification (120) describing one or more properties of the second communication session, wherein the user interface element includes a selectable control element for terminating the first communication session for a client computing device (11C), in response to determining that the time gap (401) between the first communication session (141A) and the second communication session (141B) is below the time gap threshold (402), and in response to determining that the elapsed time (503) of the first communication session (141A) is within the timing threshold (501) of the end time (502) of the first communication session (141A).

The routine can also include the generation of a prioritized list, shown in FIG. 5. This shows a prioritized list of meetings among many scheduled at the same time slot. The list is prioritized based on at least one of user preferences, user attendance history, response status, time proximity, and/or recurrence status. The operations include analyzing a number of upcoming communication sessions to determine a priority for each upcoming communication session based on at least one of user preferences, user attendance history, response status, time proximity, or recurrence status meeting one or more criteria; and configuring the notification with a list of the upcoming communication sessions that is ordered according to the determined priority for each upcoming communication session, wherein the second communication session is one of the upcoming communication sessions.

FIG. 5 also shows an example where the system selects meeting properties to display to the user, e.g., recurring meeting, response status, etc. These operations include analyzing upcoming communication sessions to select a characteristic of individual communication sessions for display on the notification, the selection based on a user attendance history, response status, time proximity, or recurrence status meeting one or more criteria with respect to one or more user preferences; and causing a display of the selected characteristics for one or more upcoming communication sessions displayed on the notification comprising a list of the upcoming communication sessions, wherein second communication session is one of the upcoming communication sessions.

FIG. 6 shows an example here the system selects more than one meeting for the user to attend, and the system switches between the two meetings. These operations include generating communication switch control data 350 that causes automatic changes between the second communication session and a third communication session, wherein a time of transitions the second communication session and the third communication session is based on a time of an agenda item of at least the second communication session and the third communication session, wherein agenda items are selected by at least one of a rank of the second communication session, the third communication session, or at least one agenda item of the second communication session or the third communication session.

In some embodiments, the system can generate communication switch control data 350 that causes automatic switches between communication sessions meeting in response to the system detecting one or more criteria. The communication switch control data 350 causes the system to switch between meetings for a particular user. For instance, the communication switch control data can cause the third user to attend a first meeting first block of time, a second meeting for a second block of time, and a third meeting for a third block of time. The blocks of time are determined based on a selection of meeting sections that meet one more criteria for a particular user. For example, a user preference file can indicate that a user prefers to attend program introductions over discussions pertaining to the review of performance metrics or discussions pertaining to department goals. In addition, preferences may indicate that a particular user prefers to participate in discussions regarding review of performance metrics over policy discussions. User preferences also indicate that the user prefers to attend question and answer sessions for particular topic such as performance metrics over question and answer sessions pertaining to department goals. The preferences can be based on a preference file or any of the preferences generated from an analysis of historical behavioral information. The historical behavioral information can be based on a number of meetings that the user has attended, their level of activity/engagement in each of the meetings, a number of files or messages pertaining to a subject, etc. When such data is used, the system can generate a score indicating a preference for a subject or people who attended meetings with the user. The system can then select meeting sections pertaining to those determined subjects or people. The system can then cause a UI to switch between those meeting sections.

These preferences can also be derived from a large language model where the system can generate a prompt, including a person's past meetings with queries that caused the large language model to generate preferences, based on subject, matters of meetings, and or discussions within those meetings. A level of engagement can be also derived from past performance by analysis of transcripts, emails, chat messages, meeting attendance records, or other content provided by a user. The preferences can be derived from a large language model analyzing previous communication records, meeting records, shared content, sent to a model with a prompt to generate the user preferences.

In the example of FIG. 6, the system can analyze those preferences and cause this computer of the third user to switch between the first upcoming meeting for a first period of time attend the second upcoming meeting for a second period of time and attend the third upcoming meeting for a third period of time. Each period of time can be based on an agenda of each meeting, or other activity pertaining to the activity of a person or shared content. In one example, the first meeting can be attended during the introduction. Based on the agenda of the first meeting, the second period of time can be based on the agenda of the first meeting and the agenda of the second meeting. The end of the first period of time can be based on the agenda of the first meeting, and the end of the second period of time can be based on the start of the Q&A session for the third meeting. The time of each transition can also be dynamically changed based on the activity of a preferred person, e.g., a CEO starting to speak in a meeting, or someone sharing a document having preferred subject matter in a meeting.

FIG. 9 shows an example here the system uses AI to determine a user's historical patterns and prioritizing meetings based on the historical patterns. These operations include generating a query that includes a first set of calendar events that are dated prior to a predetermined date as grounding data for a large language model, the query including a second set of calendar events that are dated after the predetermined date and indicated as upcoming events, the query including instructions that cause the large language model to identify behavioral patterns of the user from the grounding data and to rank the upcoming events based on the behavioral patterns of the user; communicating the query to the large language model causing the large language model to rank the upcoming events based on the behavioral patterns of the user; and receiving notification parameters (170) from the large language model, the notification parameters (170) defining a rank of the upcoming events, wherein the notification parameters (170) cause the notification to include a list of the upcoming events ranked according to the notification parameters (170), wherein the upcoming events includes the second communication session as one of the upcoming events. For example, in FIG. 2C, the notification parameters can include metadata indicating that the third communication session 141C is to be ranked higher than the second communication session 141B because User C has a history of attending meetings they hosted over conflicting meetings hosted by other people.

The routine also includes operations that cause a system to receive an input from a user to select the second meeting. This selection can be done by a user input or a computer generated selection based on the techniques disclosed herein. These operations can include a notification (120) describing one or more properties of the second communication session includes a second selectable control element for receiving an input to select the second communication session, wherein the method further comprises: receiving an input at the second selectable control element, wherein the activation of the communication of the at least one of audio signals or video signals of the second communication session is also in response to the input received at the second selectable control element.

The routine also includes operations that cause a system to filter the displayed certain meetings on a notification. For example, in the example of FIG. 1B, the second meeting would not be displayed if it is not within the threshold time gap. These operations cause the system to restrict the display of the user interface element displaying the notification describing the one or more properties of the second communication session in response to determining that the time gap between the first communication session and the second communication session is above the time gap threshold.

In a first embodiment of the processes described above, during a first meeting, the system receives a user selection of a second meeting, then when the user leaves the first meeting, the system automatically transitions to the second meeting by terminating communication of video and audio streams of the first meeting and invoking the communication of video and audio streams for the second meeting. The user can leave the meeting by providing an input to end their participation, e.g., by selecting a “Leave” menu option, or the user leaves the meeting when the host of the meeting ends the session.

In a second embodiment of the processes described above, without requiring a user input during a first meeting, the system calls into the second meeting at the start time of a second meeting that is adjacent or overlapping with the first meeting. This call to the second meeting is an interim transition where, in this interim operational state, the user is not communicating video or audio streams of the second meeting. In this interim operational state, the user is still communicating video and audio streams with the first meeting. Also, in this interim operational state, the system allows the user to access content and/or starts a recording for the second meeting. The system only transitions to a second operating state where the computer of the user communicates video or audio streams of the second meeting after the user leaves the first meeting. If there are other meetings overlapping the second meeting, the system can enter the interim operational state for each meeting. The user can provide a selection of the second meeting from the other overlapping meetings at any time, e.g., prior to the transition to the second operating state; or at a time prior to the transition to the second operating state, the system can provide a notification listing all available meetings allowing a user selection of a particular meeting for invoking the second operating state to enter that selected meeting.

In the second embodiment, the system can provide a notification providing information describing the second meeting. Then, when the user leaves the first meeting, the system provides an option for the user to join the next meeting before disconnecting the first meeting. In this embodiment, the user concurrently has an active status for the first meeting and the second meeting. This method provides a number of technical benefits in that the user can join the second meeting before leaving the first meeting, and observe activity in that second meeting before leaving the first meeting. This way, if the user joins the second meeting, finds that the second meeting isn't underway, the user can revert back to the first meeting without disrupting the first meeting. In another variation of the second embodiment, the system can provide a notification providing information describing the second meeting. Then, when the user leaves the first meeting, the system automatically transitions the user to the second meeting without a prompt requiring the user to verify the meeting. If the user has multiple meetings that have a start time after the start time of the first meeting, the system can select one of those meetings and automatically join that meeting without requiring a user input.

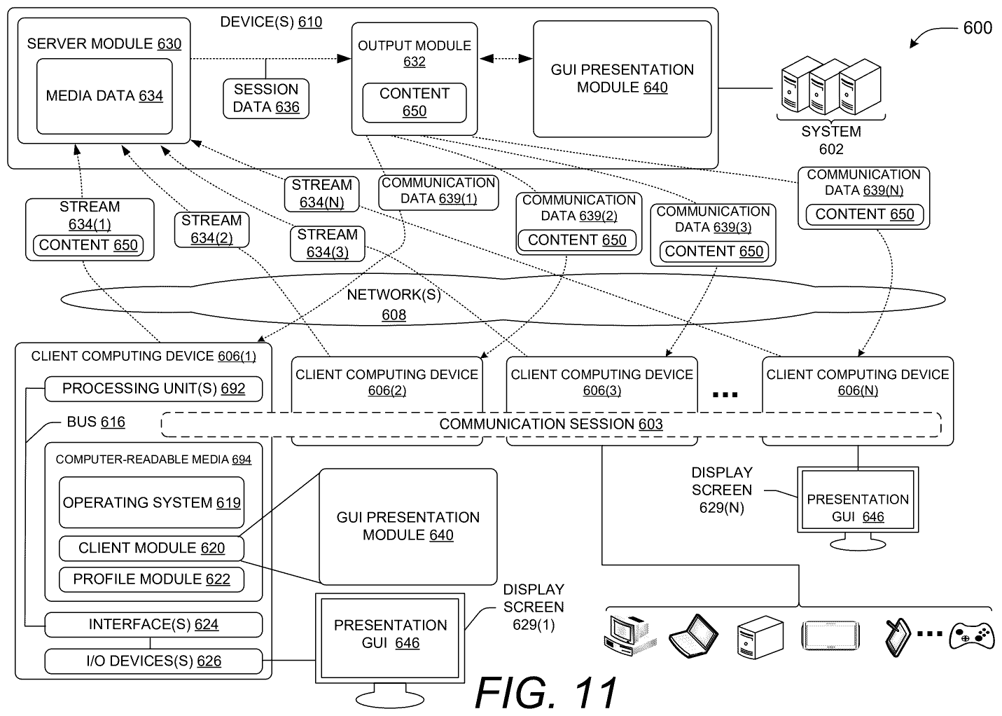

Turning now to FIG. 11, a diagram illustrating an example environment 600 in which a system 602 can implement the disclosed techniques is shown. It should be appreciated that the above-described subject matter may be implemented as a computer-controlled apparatus, a computer process, a computing system, or as an article of manufacture such as a computer-readable storage medium. The operations of the example methods are illustrated in individual blocks and summarized with reference to those blocks. The methods are illustrated as logical flows of blocks, each block of which can represent one or more operations that can be implemented in hardware, software, or a combination thereof. In the context of software, the operations represent computer-executable instructions stored on one or more computer-readable media that, when executed by one or more processors, enable the one or more processors to perform the recited operations.

Generally, computer-executable instructions include routines, programs, objects, modules, components, data structures, and the like that perform particular functions or implement particular abstract data types. The order in which the operations are described is not intended to be construed as a limitation, and any number of the described operations can be executed in any order, combined in any order, subdivided into multiple sub-operations, and/or executed in parallel to implement the described processes. The described processes can be performed by resources associated with one or more device(s) such as one or more internal or external CPUs or GPUs, and/or one or more pieces of hardware logic such as field-programmable gate arrays (“FPGAs”), digital signal processors (“DSPs”), or other types of accelerators.

All of the methods and processes described above may be embodied in, and fully automated via, software code modules executed by one or more general purpose computers or processors. The code modules may be stored in any type of computer-readable storage medium or other computer storage device, such as those described below. Some or all of the methods may alternatively be embodied in specialized computer hardware, such as that described below.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the examples described herein in which elements or functions may be deleted, or executed out of order from that shown or discussed, including substantially synchronously or in reverse order, depending on the functionality involved as would be understood by those skilled in the art.

In some implementations, a system 602 may function to collect, analyze, and share data that is displayed to users of a communication session 603. As illustrated, the communication session 603 may be implemented between a number of client computing devices 606(1) through 606(N) (where N is a number having a value of two or greater) that are associated with or are part of the system 602. The client computing devices 606(1) through 606(N) enable users, also referred to as individuals, to participate in the communication session 603.

In this example, the communication session 603 is hosted, over one or more network(s) 608, by the system 602. That is, the system 602 can provide a service that enables users of the client computing devices 606(1) through 606(N) to participate in the communication session 603 (e.g., via a live viewing and/or a recorded viewing). Consequently, a “participant” to the communication session 603 can comprise a user and/or a client computing device (e.g., multiple users may be in a room participating in a communication session via the use of a single client computing device), each of which can communicate with other participants. As an alternative, the communication session 603 can be hosted by one of the client computing devices 606(1) through 606(N) utilizing peer-to-peer technologies. The system 602 can also host chat conversations and other team collaboration functionality (e.g., as part of an application suite).

In some implementations, such chat conversations and other team collaboration functionality are considered external communication sessions distinct from the communication session 603. A computing system 602 that collects participant data in the communication session 603 may be able to link to such external communication sessions. Therefore, the system may receive information, such as date, time, session particulars, and the like, that enables connectivity to such external communication sessions. In one example, a chat conversation can be conducted in accordance with the communication session 603. Additionally, the system 602 may host the communication session 603, which includes at least a plurality of participants co-located at a meeting location, such as a meeting room or auditorium, or located in disparate locations.

In examples described herein, client computing devices 606(1) through 606(N) participating in the communication session 603 are configured to receive and render for display, on a user interface of a display screen, communication data. The communication data can comprise a collection of various instances, or streams, of live content and/or recorded content. The collection of various instances, or streams, of live content and/or recorded content may be provided by one or more cameras, such as video cameras. For example, an individual stream of live or recorded content can comprise media data associated with a video feed provided by a video camera (e.g., audio and visual data that capture the appearance and speech of a user participating in the communication session). In some implementations, the video feeds can be communicated with the messages.

The system 602 of FIG. 11 includes device(s) 610. The device(s) 610 and/or other components of the system 602 can include distributed computing resources that communicate with one another and/or with the client computing devices 606(1) through 606(N) via the one or more network(s) 608. In some examples, the system 602 may be an independent system that is tasked with managing aspects of one or more communication sessions such as communication session 603. As an example, the system 602 may be managed by entities such as SLACK, WEBEX, GOTOMEETING, GOOGLE HANGOUTS, etc.

Network(s) 608 may include, for example, public networks such as the Internet, private networks such as an institutional and/or personal intranet, or some combination of private and public networks. Network(s) 608 may also include any type of wired and/or wireless network, including but not limited to local area networks (“LANs”), wide area networks (“WANs”), satellite networks, cable networks, Wi-Fi networks, WiMax networks, mobile communications networks (e.g., 3G, 4G, and so forth) or any combination thereof. Network(s) 608 may utilize communications protocols, including packet-based and/or datagram-based protocols such as Internet protocol (“IP”), transmission control protocol (“TCP”), user datagram protocol (“UDP”), or other types of protocols. Moreover, network(s) 608 may also include a number of devices that facilitate network communications and/or form a hardware basis for the networks, such as switches, routers, gateways, access points, firewalls, base stations, repeaters, backbone devices, and the like.

In some examples, network(s) 608 may further include devices that enable connection to a wireless network, such as a wireless access point (“WAP”). Examples support connectivity through WAPs that send and receive data over various electromagnetic frequencies (e.g., radio frequencies), including WAPs that support Institute of Electrical and Electronics Engineers (“IEEE”) 802.11 standards (e.g., 802.11g, 802.11n, 802.11 ac and so forth), and other standards.

In various examples, device(s) 610 may include one or more computing devices that operate in a cluster or other grouped configuration to share resources, balance load, increase performance, provide fail-over support or redundancy, or for other purposes. For instance, device(s) 610 may belong to a variety of classes of devices such as traditional server-type devices, desktop computer-type devices, and/or mobile-type devices. Thus, although illustrated as a single type of device or a server-type device, device(s) 610 may include a diverse variety of device types and are not limited to a particular type of device. Device(s) 610 may represent, but are not limited to, server computers, desktop computers, web-server computers, personal computers, mobile computers, laptop computers, tablet computers, or any other sort of computing device.

A client computing device (e.g., one of client computing device(s) 606(1) through 606(N)) (each of which are also referred to herein as a “data processing system”) may belong to a variety of classes of devices, which may be the same as, or different from, device(s) 610, such as traditional client-type devices, desktop computer-type devices, mobile-type devices, special purpose-type devices, embedded-type devices, and/or wearable-type devices. Thus, a client computing device can include, but is not limited to, a desktop computer, a game console and/or a gaming device, a tablet computer, a personal data assistant (“PDA”), a mobile phone/tablet hybrid, a laptop computer, a telecommunication device, a computer navigation type client computing device such as a satellite-based navigation system including a global positioning system (“GPS”) device, a wearable device, a virtual reality (“VR”) device, an augmented reality (“AR”) device, an implanted computing device, an automotive computer, a network-enabled television, a thin client, a terminal, an Internet of Things (“IoT”) device, a work station, a media player, a personal video recorder (“PVR”), a set-top box, a camera, an integrated component (e.g., a peripheral device) for inclusion in a computing device, an appliance, or any other sort of computing device. Moreover, the client computing device may include a combination of the earlier listed examples of the client computing device such as, for example, desktop computer-type devices or a mobile-type device in combination with a wearable device, etc.

Client computing device(s) 606(1) through 606(N) of the various classes and device types can represent any type of computing device having one or more data processing unit(s) 692 operably connected to computer-readable media 694 such as via a bus 616, which in some instances can include one or more of a system bus, a data bus, an address bus, a PCI bus, a Mini-PCI bus, and any variety of local, peripheral, and/or independent buses. Executable instructions stored on computer-readable media 694 may include, for example, an operating system 619, a client module 620, a profile module 622, and other modules, programs, or applications that are loadable and executable by data processing units(s) 692.

Client computing device(s) 606(1) through 606(N) may also include one or more interface(s) 624 to enable communications between client computing device(s) 606(1) through 606(N) and other networked devices, such as device(s) 610, over network(s) 608. Such network interface(s) 624 may include one or more network interface controllers (NICs) or other types of transceiver devices to send and receive communications and/or data over a network. Moreover, client computing device(s) 606(1) through 606(N) can include input/output (“I/O”) interfaces (devices) 626 that enable communications with input/output devices such as user input devices including peripheral input devices (e.g., a game controller, a keyboard, a mouse, a pen, a voice input device such as a microphone, a video camera for obtaining and providing video feeds and/or still images, a touch input device, a gestural input device, and the like) and/or output devices including peripheral output devices (e.g., a display, a printer, audio speakers, a haptic output device, and the like). FIG. 11 illustrates that client computing device 606(1) is in some way connected to a display device (e.g., a display screen 629(N)), which can display a UI according to the techniques described herein.

In the example environment 600 of FIG. 11, client computing devices 606(1) through 606(N) may use their respective client modules 620 to connect with one another and/or other external device(s) in order to participate in the communication session 603, or in order to contribute activity to a collaboration environment. For instance, a first user may utilize a client computing device 606(1) to communicate with a second user of another client computing device 606(2). When executing client modules 620, the users may share data, which may cause the client computing device 606(1) to connect to the system 602 and/or the other client computing devices 606(2) through 606(N) over the network(s) 608.

The client computing device(s) 606(1) through 606(N) may use their respective profile modules 622 to generate participant profiles (not shown in FIG. 11) and provide the participant profiles to other client computing devices and/or to the device(s) 610 of the system 602. A participant profile may include one or more of an identity of a user or a group of users (e.g., a name, a unique identifier (“ID”), etc.), user data such as personal data, machine data such as location (e.g., an IP address, a room in a building, etc.) and technical capabilities, etc. Participant profiles may be utilized to register participants for communication sessions.

As shown in FIG. 11, the device(s) 610 of the system 602 include a server module 630 and an output module 632. In this example, the server module 630 is configured to receive, from individual client computing devices such as client computing devices 606(1) through 606(N), media streams 634(1) through 634(N). As described above, media streams can comprise a video feed (e.g., audio and visual data associated with a user), audio data which is to be output with a presentation of an avatar of a user (e.g., an audio only experience in which video data of the user is not transmitted), text data (e.g., text messages), file data and/or screen sharing data (e.g., a document, a slide deck, an image, a video displayed on a display screen, etc.), and so forth. Thus, the server module 630 is configured to receive a collection of various media streams 634(1) through 634(N) during a live viewing of the communication session 603 (the collection being referred to herein as “media data 634”). In some scenarios, not all of the client computing devices that participate in the communication session 603 provide a media stream. For example, a client computing device may only be a consuming, or a “listening”, device such that it only receives content associated with the communication session 603 but does not provide any content to the communication session 603.

In various examples, the server module 630 can select aspects of the media streams 634 that are to be shared with individual ones of the participating client computing devices 606(1) through 606(N). Consequently, the server module 630 may be configured to generate session data 636 based on the streams 634 and/or pass the session data 636 to the output module 632. Then, the output module 632 may communicate communication data 639 to the client computing devices (e.g., client computing devices 606(1) through 606(3) participating in a live viewing of the communication session). The communication data 639 may include video, audio, and/or other content data, provided by the output module 632 based on content 650 associated with the output module 632 and based on received session data 636. The content 650 can include the streams 634 or other shared data, such as an image file, a spreadsheet file, a slide deck, a document, etc. The streams 634 can include a video component depicting images captured by an I/O device 626 on each client computer. The content 650 also include input data from each user, which can be used to control a direction and location of a representation. The content can also include instructions for sharing data and identifiers for recipients of the shared data. Thus, the content 650 is also referred to herein as input data 650 or an input 650.

As shown, the output module 632 transmits communication data 639(1) to client computing device 606(1), and transmits communication data 639(2) to client computing device 606(2), and transmits communication data 639(3) to client computing device 606(3), etc. The communication data 639 transmitted to the client computing devices can be the same or can be different (e.g., positioning of streams of content within a user interface may vary from one device to the next). The communication data 639 can also include status data of each user in a communication session, e.g., a meeting. For example, the communication data 639 can indicate which users are still participating in a meeting, which users have left the meeting, and other activity data, e.g., which users are actively speaking, how often each user has spoken, shared content, provided a message, etc.

In various implementations, the device(s) 610 and/or the client module 620 can include GUI presentation module 640. The GUI presentation module 640 may be configured to analyze communication data 639 that is for delivery to one or more of the client computing devices 606. Specifically, the UI presentation module 640, at the device(s) 610 and/or the client computing device 606, may analyze communication data 639 to determine an appropriate manner for displaying video, image, and/or content on the display screen 629 of an associated client computing device 606. In some implementations, the GUI presentation module 640 may provide video, image, and/or content to a presentation GUI 646 rendered on the display screen 629 of the associated client computing device 606. The presentation GUI 646 may be caused to be rendered on the display screen 629 by the GUI presentation module 640. The presentation GUI 646 may include the video, image, and/or content analyzed by the GUI presentation module 640.

In some implementations, the presentation GUI 646 may include a plurality of sections or grids that may render or comprise video, image, and/or content for display on the display screen 629. For example, a first section of the presentation GUI 646 may include a video feed of a presenter or individual, a second section of the presentation GUI 646 may include a video feed of an individual consuming meeting information provided by the presenter or individual. The GUI presentation module 640 may populate the first and second sections of the presentation GUI 646 in a manner that properly imitates an environment experience that the presenter and the individual may be sharing.

In some implementations, the GUI presentation module 640 may enlarge or provide a zoomed view of the individual represented by the video feed in order to highlight a reaction, such as a facial feature, the individual had to the presenter. In some implementations, the presentation GUI 646 may include a video feed of a plurality of participants associated with a meeting, such as a general communication session. In other implementations, the presentation GUI 646 may be associated with a channel, such as a chat channel, enterprise Teams channel, or the like. Therefore, the presentation GUI 646 may be associated with an external communication session that is different from the general communication session.

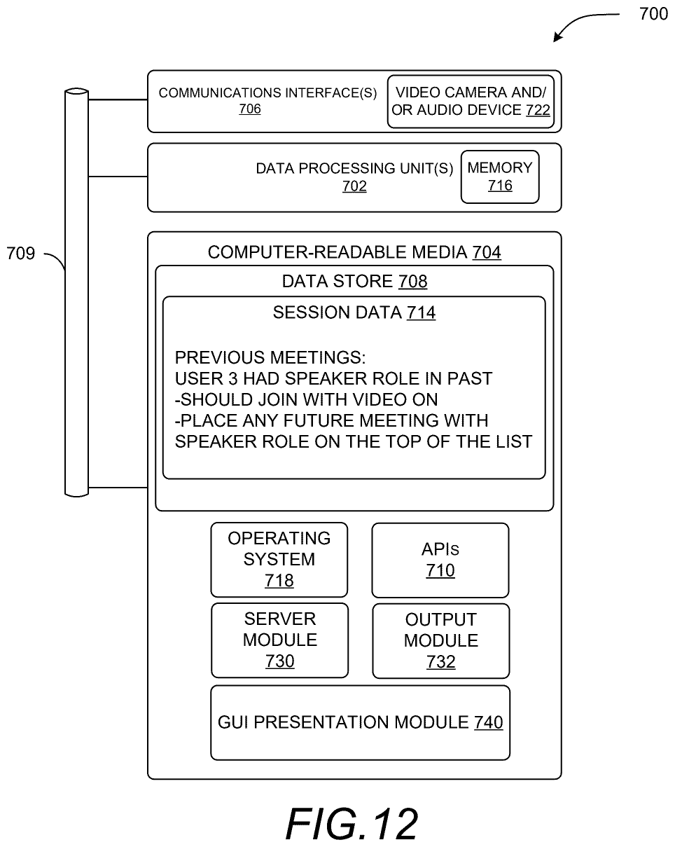

FIG. 12 illustrates a diagram that shows example components of an example device 700 (also referred to herein as a “computing device”) configured to generate data for some of the user interfaces disclosed herein. The device 700 may generate data that may include one or more sections that may render or comprise video, images, virtual objects, and/or content for display on the display screen 629. The device 700 may represent one of the device(s) described herein. Additionally, or alternatively, the device 700 may represent one of the client computing devices 606.

As illustrated, the device 700 includes one or more data processing unit(s) 702, computer-readable media 704, and communication interface(s) 706. The components of the device 700 are operatively connected, for example, via a bus 709, which may include one or more of a system bus, a data bus, an address bus, a PCI bus, a Mini-PCI bus, and any variety of local, peripheral, and/or independent buses.

As utilized herein, data processing unit(s), such as the data processing unit(s) 702 and/or data processing unit(s) 692, may represent, for example, a CPU-type data processing unit, a GPU-type data processing unit, a field-programmable gate array (“FPGA”), another class of DSP, or other hardware logic components that may, in some instances, be driven by a CPU. For example, and without limitation, illustrative types of hardware logic components that may be utilized include Application-Specific Integrated Circuits (“ASICs”), Application-Specific Standard Products (“ASSPs”), System-on-a-Chip Systems (“SOCs”), Complex Programmable Logic Devices (“CPLDs”), etc.

As utilized herein, computer-readable media, such as computer-readable media 704 and computer-readable media 694, may store instructions executable by the data processing unit(s). The computer-readable media may also store instructions executable by external data processing units such as by an external CPU, an external GPU, and/or executable by an external accelerator, such as an FPGA type accelerator, a DSP type accelerator, or any other internal or external accelerator. In various examples, at least one CPU, GPU, and/or accelerator is incorporated in a computing device, while in some examples one or more of a CPU, GPU, and/or accelerator is external to a computing device.

Computer-readable media, which might also be referred to herein as a computer-readable medium, may include computer storage media and/or communication media. Computer storage media may include one or more of volatile memory, nonvolatile memory, and/or other persistent and/or auxiliary computer storage media, removable and non-removable computer storage media implemented in any method or technology for storage of information such as computer-readable instructions, data structures, program modules, or other data. Thus, computer storage media includes tangible and/or physical forms of media included in a device and/or hardware component that is part of a device or external to a device, including but not limited to random access memory (“RAM”), static random-access memory (“SRAM”), dynamic random-access memory (“DRAM”), phase change memory (“PCM”), read-only memory (“ROM”), erasable programmable read-only memory (“EPROM”), electrically erasable programmable read-only memory (“EEPROM”), flash memory, compact disc read-only memory (“CD-ROM”), digital versatile disks (“DVDs”), optical cards or other optical storage media, magnetic cassettes, magnetic tape, magnetic disk storage, magnetic cards or other magnetic storage devices or media, solid-state memory devices, storage arrays, network attached storage, storage area networks, hosted computer storage or any other storage memory, storage device, and/or storage medium that can be used to store and maintain information for access by a computing device. The computer storage media can also be referred to herein as computer-readable storage media, non-transitory computer-readable storage media, non-transitory computer-readable medium, computer-readable storage medium, computer-readable storage device, or computer storage medium.

In contrast to computer storage media, communication media may embody computer-readable instructions, data structures, program modules, or other data in a modulated data signal, such as a carrier wave, or other transmission mechanism. As defined herein, computer storage media does not include communication media. That is, computer storage media does not include communications media consisting solely of a modulated data signal, a carrier wave, or a propagated signal, per se.

Communication interface(s) 706 may represent, for example, network interface controllers (“NICs”) or other types of transceiver devices to send and receive communications over a network. Furthermore, the communication interface(s) 706 may include one or more video cameras and/or audio devices 722 to enable generation of video feeds and/or still images, and so forth.

In the illustrated example, computer-readable media 704 includes a data store 708. In some examples, the data store 708 includes data storage such as a database, data warehouse, or other type of structured or unstructured data storage. In some examples, the data store 708 includes a corpus and/or a relational database with one or more tables, indices, stored procedures, and so forth to enable data access including one or more of hypertext markup language (“HTML”) tables, resource description framework (“RDF”) tables, web ontology language (“OWL”) tables, and/or extensible markup language (“XML”) tables, for example.

The data store 708 may store data for the operations of processes, applications, components, and/or modules stored in computer-readable media 704 and/or executed by data processing unit(s) 702 and/or accelerator(s). For instance, in some examples, the data store 708 may store session data 710 (e.g., session data 636 as shown in FIG. 12), profile data (e.g., associated with a participant profile), and/or other data. The session data 710 can include a total number of participants (e.g., users and/or client computing devices) in a communication session, activity that occurs in the communication session, a list of invitees to the communication session, and/or other data related to when and how the communication session is conducted or hosted. The data store 708 may also include session data 714, such as the content that includes video, audio, or other content that can be shared in a meeting. This the session data 714 can also include permissions for each user. For example, session data can indicate that past meetings included users having speaker roles and other roles. This data can also indicate preferences, e.g., that a user wants to join meetings with video broadcasting turned on and preferences to indicate that they wish to prioritize meetings that lists them as a presenter as a high priority meeting. In another example, a role of a designated presenter can be granted to some users and other users can have an audience role.

Alternately, some or all of the above-referenced data can be stored on separate memories 716 on board one or more data processing unit(s) 702 such as a memory on board a CPU-type processor, a GPU-type processor, an FPGA-type accelerator, a DSP-type accelerator, and/or another accelerator. In this example, the computer-readable media 704 also includes an operating system 718 and application programming interface(s) 710 (APIs) configured to expose the functionality and the data of the device 700 to other devices. Additionally, the computer-readable media 704 includes one or more modules such as the server module 730, the output module 732, and the GUI presentation module 740, although the number of illustrated modules is just an example, and the number may vary. That is, functionality described herein in association with the illustrated modules may be performed by a fewer number of modules or a larger number of modules on one device or spread across multiple devices.

In closing, although the various configurations have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

I/We claim:

1. A method for controlling transitions between communication sessions for execution on a system, the method comprising:
invoking a first communication session in an automated transition operating mode that causes the system to retrieve and display upcoming communication session properties in response to determining that the first communication session has ended, is terminated, or has concluded;
during the first communication session, determining that the first communication session has ended, is terminated, or has concluded;
in response to determining that the first communication session has ended, is terminated, or has concluded:
retrieving one or more properties for upcoming communication sessions having a time gap with the first communication session meeting one or more criteria;
causing a display of a user interface element describing the one or more properties for upcoming communication sessions having the time gap with the first communication session meeting the one or more criteria, the upcoming communication sessions being ranked based on at least one of user preferences, user attendance history, response status, time proximity, or recurrence status;
receiving an input indicating a selection of a second communication session from the display of the upcoming communication sessions; and
in response to receiving the selection of the second communication session, terminating communication of at least one of audio signals or video signals of the first communication session between the client device a first set of client devices and activate communication of at least one of audio signals or video signals between the client device and a second set of computers of the second communication session.

2. The method of claim 1, further comprising:
analyzing the upcoming communication sessions to determine a priority for each of the upcoming communication sessions based on at least one of the user preferences, the user attendance history, the response status, the time proximity, or the recurrence status meeting one or more criteria; and
configuring the user interface element with a list of the upcoming communication sessions that is ordered according to the determined priority for each of the upcoming communication sessions, wherein the second communication session is one of the upcoming communication sessions.

3. The method of claim 1, further comprising:
analyzing the upcoming communication sessions to select a characteristic of individual communication sessions for display on the user interface element, the selection based on a user attendance history, response status, time proximity, or recurrence status meeting one or more criteria with respect to one or more user preferences; and
causing a display of the selected characteristics for one or more of the upcoming communication sessions displayed on the user interface element comprising a list of the upcoming communication sessions, wherein second communication session is one of the upcoming communication sessions.

4. The method of claim 1, further comprising: generating communication switch control data 350 that causes automatic changes between the second communication session and a third communication session, wherein a time of transitions the second communication session and the third communication session is based on a time of an agenda item of at least the second communication session and the third communication session, wherein agenda items are selected by at least one of a rank of the second communication session, the third communication session, or at least one agenda item of the second communication session or the third communication session.

5. The method of claim 1, further comprising:
generating a query that includes a first set of calendar events that are dated prior to a predetermined date as grounding data for a large language model, the query including a second set of calendar events that are dated after the predetermined date and indicated as upcoming communication sessions, the query including instructions that cause the large language model to identify behavioral patterns of the user from the grounding data and to rank the upcoming communication sessions based on the behavioral patterns of the user;
communicating the query to the large language model causing the large language model to rank the upcoming communication sessions based on the behavioral patterns of the user; and
receiving notification parameters from the large language model, the notification parameters defining a rank of the upcoming communication sessions, wherein the notification parameters cause the user interface element to include a list of the upcoming communication sessions that are ranked according to the notification parameters, wherein the upcoming communication sessions includes the second communication session as one of the upcoming communication sessions.

6. The method of claim 1, wherein the system restricts the retrieval and display of one or more properties for upcoming meetings having a time gap with the first communication session that do not meet the meeting one or more criteria.

7. The method of claim 1, wherein the system restricts an analysis of the upcoming communication sessions to determine a rank for each of the upcoming communication sessions having a time gap with the first communication session that do not meet the meeting one or more criteria.

8. A method for controlling transitions between communication sessions for execution on a system, the method comprising:
invoking a first communication session in a first operating mode that causes the system to restrict an automatic transition to a second communication when a client device associated with a user terminates the first communication session;
cause an analysis of calendar data to determine that a time gap between a first communication session and a second communication session is less than a time gap threshold;
analyzing an elapsed time during the first communication session to determine that the elapsed time of the first communication session is within a timing threshold of an end time of the first communication session;
in response to determining that the time gap between the first communication session and the second communication session is below the time gap threshold, and in response to determining that the elapsed time of the first communication session is within the timing threshold of the end time of the first communication session, cause a display of a user interface element displaying a notification describing one or more properties of the second communication session, wherein the user interface element includes a control element for selecting the second communication session;
receiving an input at the control element indicating a selection of the second communication session;
invoking a second operating mode that causes the system to automatically terminate communication of at least one of audio signals or video signals of the first communication session between the client device a first set of client devices and activate communication of at least one of audio signals or video signals between the client device and a second set of computers of the second communication session in response to an input for terminating the first communication session;
receiving an input for terminating the first communication session for the client device of the user; and
in response to receiving the input for terminating the first communication session for the client computing device, terminating communication of at least one of audio signals or video signals of the first communication session with a first set of computers of the first communication session, and activating communication of at least one of audio signals or video signals of the second communication session with a second set of computers of the second communication session.

9. The method of claim 8, further comprising:
analyzing a number of upcoming communication sessions to determine a priority for each upcoming communication session based on at least one of user preferences, user attendance history, response status, time proximity, or recurrence status meeting one or more criteria; and
configuring the notification with a list of the upcoming communication sessions that is ordered according to the determined priority for each upcoming communication session, wherein the second communication session is one of the upcoming communication sessions.

10. The method of claim 8, further comprising:
analyzing upcoming communication sessions to select a characteristic of individual communication sessions for display on the notification, the selection based on a user attendance history, response status, time proximity, or recurrence status meeting one or more criteria with respect to one or more user preferences; and
causing a display of the selected characteristics for one or more upcoming communication sessions displayed on the notification comprising a list of the upcoming communication sessions, wherein second communication session is one of the upcoming communication sessions.

11. The method of claim 8, further comprising: generating communication switch control data 350 that causes automatic changes between the second communication session and a third communication session, wherein a time of transitions the second communication session and the third communication session is based on a time of an agenda item of at least the second communication session and the third communication session, wherein agenda items are selected by at least one of a rank of the second communication session, the third communication session, or at least one agenda item of the second communication session or the third communication session.

12. The method of claim 8, further comprising:
generating a query that includes a first set of calendar events that are dated prior to a predetermined date as grounding data for a large language model, the query including a second set of calendar events that are dated after the predetermined date and indicated as upcoming events, the query including instructions that cause the large language model to identify behavioral patterns of the user from the grounding data and to rank the upcoming events based on the behavioral patterns of the user;
communicating the query to the large language model causing the large language model to rank the upcoming events based on the behavioral patterns of the user; and
receiving notification parameters from the large language model, the notification parameters defining a rank of the upcoming events, wherein the notification parameters cause the notification to include a list of the upcoming events ranked according to the notification parameters, wherein the upcoming events includes the second communication session as one of the upcoming events.

13. The method of claim 8, wherein the notification describing one or more properties of the second communication session includes a second selectable control element for receiving an input to select the second communication session, wherein the method further comprises: receiving an input at the second selectable control element, wherein the activation of the communication of the at least one of audio signals or video signals of the second communication session is also in response to the input received at the second selectable control element.

14. The method of claim 8, wherein the system restricts the display of the user interface element displaying the notification describing the one or more properties of the second communication session in response to determining that the time gap between the first communication session and the second communication session is above the time gap threshold.

15. A system for controlling transitions between communication sessions, comprising:
one or more processing units; and
a computer-readable storage medium having encoded thereon computer-executable instructions to cause the one or more processing units to:
invoke a first communication session in an automated transition operating mode that causes the system to retrieve and display upcoming communication session properties in response to determining that the first communication session has ended, is terminated, or has concluded;
during the first communication session, determine that the first communication session has ended, is terminated, or has concluded;
in response to determining that the first communication session has ended, is terminated, or has concluded:
retrieve one or more properties for upcoming communication sessions having a time gap with the first communication session meeting one or more criteria;
cause a display of a user interface element describing the one or more properties for upcoming communication sessions having the time gap with the first communication session meeting one or more criteria, the upcoming communication sessions being ranked based on at least one of user preferences, user attendance history, response status, time proximity, or recurrence status;
receive an input indicating a selection of a second communication session from the display of the upcoming communication sessions; and
in response to receiving the selection of the second communication session, terminate communication of at least one of audio signals or video signals of the first communication session between the client device a first set of client devices and activate communication of at least one of audio signals or video signals between the client device and a second set of computers of the second communication session.

16. The system of claim 15, wherein the instructions further cause the one or more processing units to:
analyze the upcoming communication sessions to determine a priority for each of the upcoming communication sessions based on at least one of the user preferences, the user attendance history, the response status, the time proximity, or the recurrence status meeting one or more criteria; and
configure the user interface element with a list of the upcoming communication sessions that is ordered according to the determined priority for each of the upcoming communication sessions, wherein the second communication session is one of the upcoming communication sessions.

17. The method of claim 1, wherein determining that the first communication has ended comprises: analyzing a calendar item defining the first communication session to determine that a running time of the first communication session is within a threshold time of an end time of the first communication session or a current time has passed the end time, wherein the display of the user interface element describing the one or more properties for the upcoming communication sessions is displayed in response to determining that the running time of the first communication session is within the threshold time of the end time of the first communication session or the current time has passed the end time.

18. The method of claim 1, wherein determining that the first communication is terminated comprises: receiving an input for terminating the first communication session, wherein the display of the user interface element describing the one or more properties for the upcoming communication sessions is displayed in response to receiving the input for terminating the first communication session.

19. The method of claim 1, wherein determining that the first communication has concluded comprises: analyzing communication data to determine that a threshold number of users have left the first communication session, wherein the display of the user interface element describing the one or more properties for the upcoming communication sessions is displayed in response to determining that the threshold number of users have left the first communication.

20. The system of claim 15, wherein the system restricts the retrieval and display of one or more properties for upcoming meetings having a time gap 401 with the first communication session 141A that do not meet the meeting one or more criteria.
